(19) United States
(12) Patent Application Publication
(10) Pub. No.: US 2014/0141262 A1
(43) Pub. Date: May 22, 2014

(54) VINYL ALCOHOL POLYMERS WITH SILANE SIDE CHAINS AND COMPOSITIONS COMPRISING THE SAME

(71) Applicants: Thomas Charles CASTLE, Flintshire (GB); Robert Louis FINCH, Flintshire (GB); David Alan PEARS, Flintshire (GB); Maurice PRESTON, Flintshire (GB); Pennadam Shanmugam SIVANAND, Flintshire (GB); Brian David YOUNG, Flintshire (GB); Derek Ronald ILLSLEY, Maidstone (GB)

(72) Inventors: Thomas Charles CASTLE, Flintshire (GB); Robert Louis FINCH, Flintshire (GB); David Alan PEARS, Flintshire (GB); Maurice PRESTON, Flintshire (GB); Pennadam Shanmugam SIVANAND, Flintshire (GB); Brian David YOUNG, Flintshire (GB); Derek Ronald ILLSLEY, Maidstone (GB)

(73) Assignee: SUN CHEMICAL CORPORATION, PARSIPPANY, NJ (US)

(21) Appl. No.: 14/106,975

(22) Filed: Dec. 16, 2013

(30) Foreign Application Priority Data
Jun. 29, 2011 (GB) 1111056.6
Jun. 29, 2012 (GB) PCT/GB2012/051529
Jun. 29, 2012 (US) PCT/US2012/044834

(51) Int. Cl. B65D 65/42; C08F 16/06

(52) U.S. Cl. CPC B65D 65/42; C08F 16/06
USPC 428/447; 525/61; 525/60; 524/557; 524/389; 524/445

(57) ABSTRACT

A functionalized homopolymer or copolymer of vinyl alcohol of the formula P—(R)ₙ, where: P represents a straight or branched chain polymer backbone that is a homopolymer of vinyl alcohol or a copolymer of vinyl alcohol and at least one other monomer, the homopolymer or copolymer comprising one or more reactive coupling group; R represents an aminosilane-containing and/or an aminosilanol-containing side chain attached to the polymer backbone via the one or more reactive coupling group; and n represents the number of side chains, which are present in an amount from about 1 to about 25 mol % of the polymer backbone; and ink or coating compositions containing the functionalized polymer.

This is a Continuation-in-Part of (1) International Application No. PCT/GB2012/051529 filed Jun. 29, 2012, which claims the benefit of GB 1111056.6 filed Jun. 29, 2011; and (2) International Application No. PCT/US2012/044834 filed Jun. 29, 2012, which claims the benefit of U.S. Provisional Application No. 61/502,358 filed Jun. 29, 2011. This continuation-in-part is filed under 35 U.S.C. 111(a). The disclosure of the prior applications is hereby incorporated by reference herein in its entirety.

### BACKGROUND

The present invention relates to novel functionalized homopolymers and copolymers of vinyl alcohol comprising one or more aminosilane-containing and/or aminosilanol-containing side chains attached to the polymer backbone via a reactive coupling group; to a process for the preparation of such polymers; and to the use of such polymers in coatings, inks, or adhesives.

Poly(vinyl alcohols) are commonly used as the basis, or a component, of various forms of coatings. Hydrogen bonding between the alcohol groups present in such polymers leads to a highly ordered structure with a high degree of crystallinity and high melting point. This highly crystalline, highly ordered structure makes it difficult for small molecules to pass through films comprising these polymers. However, protective films comprising poly(vinyl alcohol) and vinyl alcohol copolymers can suffer from failures in adhesion, particularly on contact with moisture or as a result of immersion in water.

Gases, vapors, and chemicals are prone to permeation through thermoplastic resin layers when subjected to varying environmental conditions such as temperature and humidity. Undesired deterioration of the thermoplastic resin layer as well as contamination of the packaged contents may result. To prevent or significantly reduce permeation, protective films are generally applied to one or more thermoplastic resin layers.

Protective films may include several layers. At least one of these layers includes a barrier layer. Barrier layers slow the ingress and/or egress of gases, such as oxygen and carbon dioxide, as well as moisture, which could otherwise cause spoilage or degradation of the packaged contents. Polyvinyl alcohols are commonly used as the barrier layer. Diffusing species such as oxygen are poorly soluble in PVOH polymers. In addition, hydrogen bonding between alcohol groups in PVOH polymers result in highly ordered structures with a high degree of crystallinity and high melting point. These structures make it difficult for small molecules to pass through

To further improve oxygen barrier properties of the barrier layer, inorganic filler particles may be added in selected amounts. More often than not, high aspect ratio fillers, i.e., greater than about 25, are employed. Aspect ratios are defined as the product of the lateral dimension divided by the thickness. While barrier layers comprising high aspect ratio fillers such as, for example vermiculites, blended with polymers provide excellent oxygen barrier properties, adhesive bond strength remains poor at high temperatures and/or high humidity.

What is desired in the field is an ink or coating composition exhibiting excellent gas barrier properties in low and high humidity environments over time. Also desired is an ink or coating composition exhibiting superior bond strength at low and high humidity environments over time. Further, a laminated package employing the above-mentioned ink or coating compositions is desired.

JP-2003-171600A describes a gas barrier coating composition comprising acetoacetyl modified polyvinyl alcohol; an amino- or imino-functionalized alkoxy silane; and water or a mixture of water and a lower alcohol. JP-2004-143197A describes a gas barrier coating composition comprising acetoacetyl modified polyvinyl alcohol; an alkoxy silane; an acid catalyst and water, or a mixture of water and a lower alcohol. The coatings described in JP-2003-171600A and JP-2004-143197A are alleged to provide high levels of gas barrier performance and adhesion which are maintained under high humidity levels.

JP-1997-291185A describes an adhesive composition comprising an acetoacetate ester functionalized poly(vinyl alcohol) resin that contains specified quantities of acetic acid and an alkali metal salt of acetic acid; and a silane compound.

The application of aqueous solutions comprising amino functionalized alkoxysilanes to flexible plastic films in the preparation of gas barrier coatings has previously been described (B. Singh et al. in Surface and Coatings Technology, 2007, 201 (16-17), 7107-7114; and ibid., 2007, 202 (2), 208-216).

### SUMMARY

Disclosed herein are novel polymers which may be used in coatings, inks or adhesives and which have improved adhesive properties compared to similar coatings, inks or adhesives prepared from unmodified poly(vinyl alcohols), and vinyl alcohol copolymers.

Ink and coating compositions in accordance with this disclosure exhibit improved gas barrier performance and/or bond strength characteristics. Also disclosed herein are laminated packages including the above-mentioned inks and coatings. Further disclosed is the use of the above-mentioned inks and coatings in flexible or rigid packaging applications including, but not limited to, foods, pharmaceuticals, and specialty chemicals.

It has surprisingly been conceived by the inventors that their ink and coating compositions exhibit improved oxygen barrier properties and bond strength characteristics. This is especially important in environments where the relative humidity exceeds 50%. In an exemplary embodiment, the ink and coating compositions are employed as barrier layers in laminated packages.

One of the many advantages of the disclosed ink and coating compositions is the occurrence of reduced oxygen transmission through a substrate. By so doing, spoilage and degradation of the packaged contents can be slowed or prevented. In one example, modified atmosphere packaging “MAP” including controlled blends of nitrogen gas and carbon dioxide are useful in barrier layers for protecting against oxygen transmission. Another advantage of the ink and coating compositions is their improved laminate bond strength at low and high humidity. Yet another advantage is the absence of chlorinated materials in the inks and coatings. A further advantage is that a primer is not required to be applied to the plastic substrate prior to the coatings for adhesively laminated structures.

In an exemplary embodiment, there is described an ink or coating composition comprising functionalized homopolymers and copolymers of vinyl alcohols comprising one or more aminosilane-containing and/or aminosilanol-containing side chains attached to the polymer backbone via a reactive coupling group. The composition may also contain an inorganic filler, in particular those with high aspect ratios. In another embodiment, there is described a process for preparing the ink or coating compositions.

Additional features and advantages of the present invention will be set forth in the description which follows, and in part will be apparent from the description, or may be learned by practice of the invention. The advantages of the invention will be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings:

FIG. 1 illustrates laminate bond strength for different polymer materials.

FIG. 2 illustrates oxygen transmission rate versus relative humidity for a plurality of coating compositions.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### DETAILED DESCRIPTION OF THE EMBODIMENTS

According to a first aspect of the present invention, there is provided a functionalized homopolymer or copolymer of vinyl alcohol of formula (I):

P—(R)ₙ (I)

wherein:

P represents a straight or branched chain polymer backbone which is a homopolymer of vinyl alcohol, or a copolymer of vinyl alcohol and at least one other monomer, said homopolymer or copolymer comprising one or more reactive coupling groups;

R represents an aminosilane- and/or aminosilanol containing side chain attached to the polymer backbone via the reactive coupling group(s); and

n represents the number of side chains, which are present in an amount from about 1 to about 25 mol % of the polymer backbone.

In another embodiment, when P represents a homopolymer of vinyl alcohol, then R is not a side chain derived from 3-aminopropyltriethoxysilane.

The polymer backbone P is a straight or branched chain homopolymer of vinyl alcohol or a copolymer of vinyl alcohol, at least one other monomer, and one or more reactive coupling groups. When the polymer backbone P is a copolymer of vinyl alcohol and at least one other monomer, the other monomer(s) preferably contain an alkene group (i.e. carbon-to-carbon double bond) capable of undergoing copolymerisation with vinyl alcohol or a suitable precursor monomer such as a vinyl ester.

In another embodiment, the polymer backbone P is a straight or branched chain homopolymer of vinyl alcohol or a copolymer of vinyl alcohol, at least one other monomer, and one or more reactive coupling groups. P represents a copolymer of vinyl alcohol and an olefin, such as ethylene or propylene, preferably ethylene. More preferably, the olefin is present in an amount from about 1 to about 50 mol %, preferably from about 2 to about 40 mol %, and more preferably from about 5 to about 20 mol % of the polymer backbone. In a further embodiment, the olefin is present in a mol % of the polymer backbone in the amount of 1%; 2%; 3%; 4%; 5%; 6%; 7%; 8%; 9%; 10%; 11%; 12%; 13%; 14%; 15%; 16%; 17%; 18%; 19%; 20%; 21%; 22%; 23%; 24%; 25%; 26%; 27%; 28%; 29%; 30%; 31%; 32%; 33%; 34%; 35%; 36%; 37%; 38%; 39%; 40%; 41%; 42%; 43%; 44%; 45%; 46%; 47%; 48%; 49% and 50%.

In an alternative preferred embodiment, P represents a copolymer of vinyl alcohol and a non-hydrocarbon alkene containing monomer, such as a vinylic (e.g. acrylic) or methacrylic monomer. Examples of suitable non-hydrocarbon alkene containing monomers which may be used in the present invention include, but are not limited to, styrene, acrylonitrile, methacrylonitrile, crotononitrile, vinyl halides, vinylidene halides, (meth)acrylamide, N,N-dimethyl acrylamide, vinyl polyethers of ethylene or propylene oxide, vinyl esters such as vinyl formate, vinyl benzoate or vinyl ethers (such as VEOVA™ 10 available from MOMENTIVE™), vinyl ethers of heterocyclic vinyl compounds, alkyl esters of mono-olefinically unsaturated dicarboxylic acids and in particular esters of acrylic and methacrylic acid; vinyl monomers with hydroxyl functionality 2-hydroxy ethyl(meth)acrylate, 2-hydroxy propyl(meth)acrylate, glycerol mono(meth)acrylate, 4-hydroxy butyl(meth)acrylate, hydroxyl stearyl methacrylate, N-methylol (meth)acrylamide; vinyl monomers with additional functionality for crosslinking or adhesion promotion or post functionalization of the vinyl polymers, such as diacetone acrylamide, aceto acetoxy ethyl(meth)acrylate, glycidyl methacrylate, 2-acrylamido-2-methylpropane sulphonic acid, (meth)acrylic acid, beta carboxy ethyl(meth)acrylate, maleic anhydride, styrene sulphonic acid, sodio sulpho propyl methacrylate, itaconic acid; N,N-dimethyl ethyl amino(meth)acrylate, N,N-diethyl ethyl amino(meth)acrylate, N,N-dimethyl ethyl amino(meth)acrylate, N,N-dimethyl propyl amino(meth)acrylate, N,N-diethyl propyl amino(meth)acrylate, vinyl pyridine, amino methyl styrene, crotonic acid, esters of crotonic acid, crotononitrile, vinyl imidazole; and basic amine monomers can be polymerised as the free amine, protonated salts or as a quaternised amine salt. Where a monomer is indicated with a prefix in brackets (e.g. meth) it shall be understood that it be used in a form with or without the methyl substitution, or alternatively an alternative alkyl group may be present. For example, in the case of acrylic acid, methacrylic acid or another derivative such as ethacrylic acid may be used.

Preferably, the non-hydrocarbon alkene containing monomer is selected from the group consisting of acrylic acid, acrylonitrile, acrylamide, 2-acrylamido-2-methylpropane sulphonic acid, methacrylic acid, methyl methacrylate, 2-hydroxyethyl acrylate, hydroxyethyl methacrylate, ethyl methacrylate and n-butyl methacrylate. In the case of a copolymer of acrylic, methacrylic or crotonic acid, the resulting copolymer may exist as a reacted adduct in the form a five-membered lactone ring.

In a further alternative preferred embodiment, P represents a copolymer of vinyl alcohol and acetoacetoxyethyl methacrylate.

In still a further alternative preferred embodiment, P represents a copolymer of diacetone acrylamide and vinyl alcohol.

As used herein, the term “reactive coupling group” means any chemical group attached to the polymer backbone that is capable of forming a bond with an aminosilane- and/or an aminosilanol containing side chain.

In a preferred embodiment, the reactive coupling group comprises a ketone- or ketoester containing functional group, preferably a ketoester containing functional group. More preferably, the reactive coupling group comprises a ketoester containing functional group derivable from an acetoacetylation agent such as diketene, diketene acetone adduct and/or tert-butyl acetoacetate. Most preferably, the ketoester containing functional group comprises the moiety —O(CO)CH—C(CH₃)═O.

In a further preferred embodiment, the ketone or ketoester containing functional group is present in an amount from about 1 to about 25 mol %, such as from about 2 to about 15 mol %, preferably from about 3 to about 8 mol % of the polymer backbone. In an exemplary embodiment, the mol % of reaction coupling groups with respect to the polymer backbone may be 1%; 2%; 3%; 4%; 5%; 6%; 7%; 8%; 9%; 10%; 11%; 12%; 13%; 14%; 15%; 16%; 17%; 18%; 19%; 20%; 21%; 22%; 23%; 24%; and 25%.

In yet another embodiment, the polymer side-chains R are derived from aminosilanes which contain at least one primary amine group capable of reacting with the reactive coupling group(s) present on the polymer backbone and also at least one silanol group (Si—OH) or a precursor group to silanol, such as an alkoxysilane or aryloxysilane. In a preferred embodiment, the side chains R are derived from a compound of general formula (IIA):

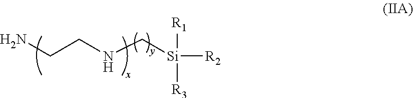

wherein,

R₁, R₂, and R₃ independently represent H, C₁₋₉ alkyl, aryl, C₁₋₉ alkoxy or aryloxy, provided that at least one of R₁, R₂, or R₃ represents a C₁₋₉ alkoxy or aryloxy group;

x is in the range from 0 to 9, preferably 0 to 2; and

y is in the range from 1 to 9, preferably 2 to 6.

In a preferred embodiment, x is 0, 1, or 2 and y is 3. In a further preferred embodiment, at least two of R₁, R₂, and R₃ independently represent C₁₋₉ alkoxy, and are preferably selected from the group consisting of methoxy, ethoxy, propoxy, and butoxy.

Alternatively, the general formula could be according to formula IIB:

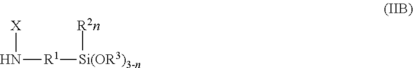

wherein:

R¹ is an alkyl or alkylene group of carbon number 1 to 4,

R² and R³ are alkyl groups of carbon number 1 to 4,

X is a hydrogen atom or aminoalkyl group, and

n is 1 or 0.

In a more preferred embodiment, the side chain R is derived from one or more of the following compounds: aminoethyl triethoxy silane, 2-aminoethyl trimethoxy silane, 2-aminoethyl triethoxy silane, 2-aminoethyl tripropoxy silane, 2-aminoethyl tributoxy silane, 1-aminoethyl trimethoxy silane, 1-aminoethyl triethoxy silane, 3-aminopropyl trimethoxy silane, 3-aminopropyl triethoxy silane, 3-aminopropyl tripropoxy silane, 3-aminopropyl tributoxy silane, 3-aminopropyl methyl dimethoxysilane, 3-aminopropyl ethyl dimethoxysilane, 3-aminopropyl-3-aminopropyldiethylethoxysilane ethyl diethoxysilane, 3-aminopropyl methyl dipropoxysilane, 3-aminopropyl ethyl dipropoxysilane, 3-aminopropyl propyl dipropoxysilane, 3-aminopropyl dimethyl methoxysilane, 3-aminopropyl dimethyl ethoxysilane, 3-aminopropyl diethyl ethoxysilane, 3-aminopropyl dimethyl propoxysilane, 3-aminopropyl diethyl propoxysilane, 3-aminopropyl dipropyl propoxysilane, 2-aminopropyl trimethoxy silane, 2-aminopropyl triethoxy silane, 2-aminopropyl tripropoxy silane, 2-aminopropyl tributoxy silane, 1-aminopropyl trimethoxy silane, 1-aminopropyl triethoxy silane, 1-aminopropyl tripropoxy silane, 1-aminopropyl tributoxy silane, N-aminomethyl aminomethyl trimethoxy silane, N-aminomethyl aminomethyl tripropoxy silane, N-aminomethyl-2-aminoethyl trimethoxy silane, N-aminomethyl-2-aminoethyl triethoxy silane, N-aminomethyl-2-aminoethyl tripropoxy silane, N-aminomethyl-3-aminopropyl trimethoxy silane, N-aminomethyl-3-aminopropyl triethoxy silane, N-aminomethyl-3-aminopropyl tripropoxy silane, N-aminomethyl-2-aminopropyl trimethoxy silane, N-aminomethyl-2-aminopropyl triethoxy silane, N-aminomethyl-2-aminopropyl tripropoxy silane, N-aminopropyl trimethoxy silane, N-aminopropyl triethoxy silane, N-(2-aminoethyl)-2-aminoethyl trimethoxy silane, N-(2-aminoethyl)-2-aminoethyl triethoxy silane, N-(2-aminoethyl)-2-aminoethyl tripropoxy silane, N-(2-aminoethyl)-aminoethyl trimethoxy silane, N-(2-aminoethyl)-1-aminoethyl triethoxy silane, N-(2-aminoethyl)-1-aminoethyl tripropoxy silane, N-(2-aminoethyl)-3-aminopropyl triethoxy silane, N-(2-aminoethyl)-3-aminopropyl tripropoxy silane, N-(3-aminopropyl)-2-aminoethyl trimethoxy silane, N-(3-aminopropyl)-2-aminoethyl triethoxy silane, N-(3-aminopropyl)-2-aminoethyl tripropoxy silane, N-methyl-3-aminopropyl trimethoxy silane, 3-aminopropyl methyl dimethoxy silane, 3-aminopropyl methyl diethoxy silane, N-(2-aminoethyl)-3-aminopropyl methyl dimethoxy silane, 3-diethylene 3-diethylene triamine propyl triethoxy silane, 3-[2-(2-aminoethyl aminoethyl amino)propyl]trimethoxysilane, 3-[2-(2-aminoethyl aminoethyl amino) propyl]triethoxysilane, 3-[2-(2-aminoethyl aminoethyl amino) propyl]tripropoxysilane, and/or trimethoxy silyl propyl diethylene triamine.

Still more preferably, the side chain R is derived from one or more of the following compounds:

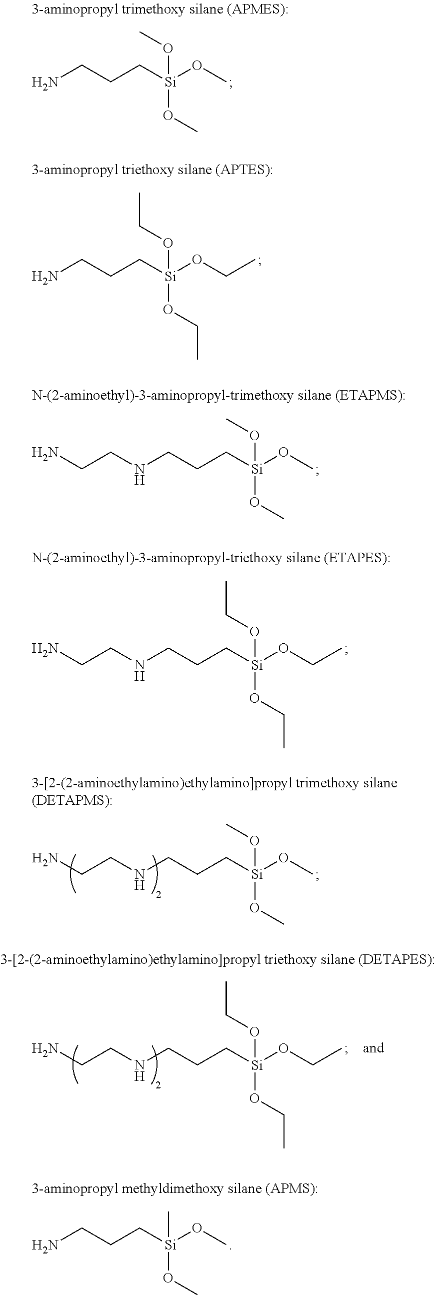

Most preferably, the side chain R is derived from 3-aminopropyl triethoxy silane, N-(2-aminoethyl)-3-aminopropyl triethoxysilane, or 3-[2-(2-aminoethylamino)ethylamino]propyl-triethoxy silane.

A suitable hydrazine or hydrazide functionalized aminosilane may also be employed in accordance with the present invention.

In a preferred embodiment, the side chains R are present in an amount from about 2 to about 15 mol %, more preferably in an amount from about 3 to about 8 mol %, of the polymer backbone. In an exemplary embodiment, the mol % of side chains in relation to the polymer backbone may be 1%; 2%; 3%; 4%; 5%; 6%; 7%; 8%; 9%; 10%; 11%; 12%; 13%; 14%; 15%; 16%; 17%; 18%; 19%; 20%; 21%; 22%; 23%; 24%; and 25%.

Alternatively, an excess of aminosilane and/or aminosilanol may be employed during the polymer synthesis relative to the reactive coupling group (e.g. ketone) present. In such instances, some of the aminosilane and/or aminosilanol may be present in an unreactive form and therefore not attached to the polymer backbone.

In an alternative preferred embodiment, the side chains R, or alternatively the aminosilane represented by formula (IIA), are present in an amount from about 25 to about 200 mol %, such as from about 50 to about 150 mol %, preferably from about 75 to about 125 mol %, relative to the amount of reactive coupling groups present on the polymer backbone. In another embodiment, the amount of side chains in relation to the amount of reactive coupling groups present in the polymer backbone is: 25%; 26%; 27%; 28%; 29%; 30%; 31%; 32%; 33%; 34%; 35%; 36%; 37%; 38%; 39%; 40%; 41%; 42%; 43%; 44%; 45%; 46%; 47%; 48%; 49%; 50%; 51%; 52%; 53%; 54%; 55%; 56%; 57%; 58%; 59%; 60; 61%; 62%; 63%; 64%; 65%; 66%; 67%; 68%; 69%; 70%; 71%; 72%; 73%; 74%; 75%; 76%; 77%; 78%; 79%; 80%; 81%; 82%; 84%; 85%; 86%; 87%; 88%; 89%; 90%; 91%; 92%; 93%; 94%; 95%; 96%; 97%; 98%; 99% 100%; 101%; 102%; 103%; 104%; 105%; 106%; 107%; 108%; 109; 110%; 111%; 112%; 113%; 114%; 115%; 116%; 117%; 118%; 119%; 120%; 121%; 122%; 123%; 124%; 125%; 126%; 127%; 128%; 129%; 130%; 131%; 132%; 133%; 134%; 135%; 136%; 137%; 138%; 139%; 140%; 141%; 142%; 143%; 144%; 145%; 146%; 147%; 148%; 149%; 150%; 151%; 152%; 153%; 154%; 155%; 156%; 157%; 158%; 159%; 160; 161%; 162%; 163%; 164%; 165%; 166%; 167%; 168%; 169%; 170%; 171%; 172%; 173%; 174%; 175%; 176%; 177%; 178%; 179%; 180%; 181%; 182%; 184%; 185%; 186%; 187%; 188%; 189%; 190%; 191%; 192%; 193%; 194%; 195%; 196%; 197%; 198%; 199%; and 200%.

It has surprisingly been found that by carefully controlling the ratio of reactive coupling groups (for example ketoester groups) to polymer backbone and/or of aminosilane side chains to reactive coupling groups, it is possible to attain outstanding adhesion of the resulting polymers to substrates when compared to the corresponding unmodified polymers (i.e. those containing no aminosilane functionalization). This advantageously allows films comprising polymers of the invention cast on substrates to be immersed in water and retain their adhesion, in contrast to corresponding unmodified polymers which are lost quickly under such conditions.

In a preferred embodiment, the polymers of the present invention are substantially free from acetic acid or an alkali metal salt thereof such as sodium acetate. Preferably, no acetic acid or metal salts thereof are added to assist in cross-linking.

According to a further aspect of the present invention, there is provided a process for preparing a functionalized vinyl alcohol homopolymer or copolymer of the type described above, comprising the steps of:

(a) preparing a straight or branched chain homopolymer of vinyl acetate or a copolymer of vinyl acetate with at least one other monomer;

(b) hydrolysing the homopolymer or copolymer of vinyl acetate of step (a) to obtain a homopolymer or copolymer of vinyl alcohol;

(c) reacting the homopolymer or copolymer of vinyl alcohol of step (b) with a suitable reactive coupling agent to obtain a homopolymer or copolymer of vinyl alcohol comprising one or more reactive coupling groups;

(d) reacting the resulting homopolymer or copolymer of vinyl alcohol comprising one or more reactive coupling groups of step (c) with a suitable aminosilane and/or an aminosilanol; and

(e) optionally isolating the copolymer so formed.

The polymer obtained upon completion of each reaction detailed in steps (a) to (d) of the above process may be isolated prior to initiation of the following step or reacted in situ.

According to one embodiment of step (a) of the above process, vinyl acetate is reacted with at least one other monomer to obtain a straight or branched chain vinyl acetate copolymer. Thereafter, according to step (b), the copolymer of vinyl acetate is hydrolysed to obtain a copolymer of vinyl alcohol. By way of example, ethylene may be copolymerised with vinyl acetate to afford an ethylene-vinyl acetate copolymer, which may be subsequently hydrolysed to form an ethylene-vinyl alcohol copolymer (EVOH), as follows:

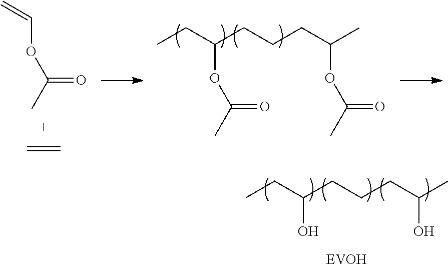

Alternatively, according to a further embodiment of step (a) of the above process, vinyl acetate is polymerised to obtain a straight or branched chain vinyl acetate homopolymer, i.e. poly(vinyl acetate). Thereafter, according to step (b), the homopolymer of vinyl acetate is hydrolysed to poly(vinyl alcohol), as follows:

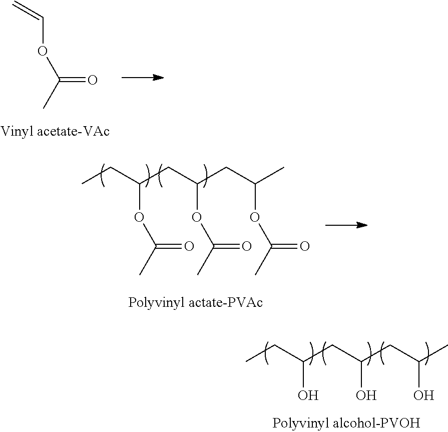

It will be appreciated that PVOH may also be prepared by the hydrolysis of other poly(vinyl esters) such as poly(vinyl formate), poly(vinyl benzoate) or poly(vinyl ethers). Similarly, a copolymer of vinyl alcohol such as EVOH may also be prepared by copolymerising the relevant monomer with a vinyl ester other than vinyl alcohol and hydrolysing the resulting polymer for instance. Such polymers are also within the scope of the present invention.

It will be appreciated that during step (b) of the process, a number of the vinyl acetate groups present may remain unhydrolysed in the resulting polymer. In a preferred embodiment, step (b) comprises partial hydrolysis of the homopolymer or copolymer of vinyl acetate; for example, between about 25 and about 100% hydrolysis, more preferably between about 50 and about 100% hydrolysis, yet more preferably between about 70 to about 100% hydrolysis, and most preferably between about 80 to about 100% hydrolysis.

Suitable poly(vinyl alcohols) for use in the process are commercially available, thereby obviating the need for steps (a) and (b) of the process, or may be prepared by conventional synthetic methods.

Thus, in one preferred embodiment, the process of the invention comprises the steps of:

(c) reacting a homopolymer or copolymer of vinyl alcohol with a suitable reactive coupling agent to obtain a homopolymer or copolymer of vinyl alcohol comprising one or more reactive coupling groups;

(d) reacting the resulting homopolymer or copolymer of vinyl alcohol comprising one or more reactive coupling groups of step (c) with a suitable aminosilane and/or an aminosilanol; and

(e) optionally isolating the copolymer so formed.

For example, poly(vinyl alcohols) are commercially available from Nippon Gohsei under the trade name GOHSENOL™ or from Kuraray under the trade name POVAL™ Suitable copolymers of vinyl alcohol, such as EVOH, for use in the process are commercially available or may be prepared by conventional synthetic methods. For example, copolymers of ethylene and vinyl alcohol are commercially available from Kuraray under the trade name EXCEVAL™ and from Nippon Gohsei under the trade name SOARNOL™.

According to step (c) of the process, the homopolymer or copolymer of vinyl alcohol is reacted with a suitable reactive coupling agent to obtain a copolymer of vinyl alcohol comprising one or more reactive coupling groups. Step (c) is typically performed in a suitable solvent (i.e. a solvent capable of solvating both the homopolymer or copolymer of vinyl alcohol and the reactive coupling agent, and that is inert to both), such as dimethylformamide (DMF), dimethylsulfoxide (DMSO) or dimethylacetamide (DMAc), at an elevated temperature in the range from about 90 to 190° C., such as about 135° C.

As an alternative to carrying out the reaction of step (c) with the reactants dissolved in a solvent, this step of the process can be carried out in the concentrated phase or by using an essentially no-solvent process. By way of example, U.S. Pat. No. 5,719,231 describes the reaction of an acetoacetate forming composition with a vinyl alcohol based polymer in the solid phase by spraying the acetoacetate forming composition onto the solid polymer at elevated temperatures. An analogous process may be employed in the present invention.

Alternatively, a paste or dispersion of the polymer in a solvent such as water or a dipolar aprotic solvent or non-solvent such as an organic acid may be made. By way of example, acetic acid may be adsorbed, sprayed or mixed with polymers of vinyl alcohol prior to reaction with diketene, in an analogous method to that described in JP-9291185A). Alternatively, a paste of the vinyl alcohol polymer in water may be made by mixing the polymer with water, optionally with elevated temperature and stirring of high intensity or by concentrating an existing solution of the polymer under vacuum for instance. The functionalization can be carried out with the polymer dispersed or suspended in a liquid medium which is a good solvent for the acetoacetylation agent. By way of example, the polymer can be dispersed in a hydrocarbon solvent such as hexane or an organic acid such as acetic acid and diketene added to the mixture. Following reaction of the acetoacetylation agent with the polymer, liquid can be separated by filtration and optionally reused in the process taking advantage of the greater degree of efficiency this offers. Unreacted acetoacetylation agent or solvent/dispersal media such as acid may be removed by evaporation, or by washing it from the material with a suitable solvent.

In the case of processes where the polymer is reacted as a solid, it will be appreciated that the particle size and shape of the granulated or powdered polymer is important. A smaller particle size will result in a greater surface area which will advantageously enable more efficient reaction with the acetoacetylation agent. As a result a product with a more homogenous degree of ketoester functionality or a greater degree of functionality if so desired may be obtained. It will be appreciated that the reaction process may be performed using any piece of equipment that is capable of providing sufficient mixing. These may include reactors or other vessels where agitation is provided by an overhead stirrer, a magnetic stirrer, most preferably mixing is achieved using an appropriate extruder, z-blade mixer, batch mixer, U trough mixer, RT mixer, compounder, internal mixer, Banbury type mixer, two roll mill, Brabender type mixer, a wide blade mixer (or hydrofoil blade mixer), horizontal (delta or helical) blade mixer, kneader-reactor, or a related variation of one of these mixers such as such as a double z-blade mixer or twin screw extruder. Heat introduced to the system may be supplied by conventional means or from microwave radiation.

Preferably, the reactive coupling group comprises a ketone- or ketoester containing functional group, more preferably a ketoester containing functional group. Suitable reagents capable of the generation of a ketoester (or acetoacetate) group are commercially available and are collectively referred to as acetoacetylation agents. In a preferred embodiment, the reactive coupling group comprises a ketoester containing functional group derived from an acetoacetylation agent. Preferred commercially available acetoacetylation agents include diketene (DK), diketene acetone adduct (DKAA), and an alkyl acetoacetate such as tert-butyl acetoacetate (t-BAA):

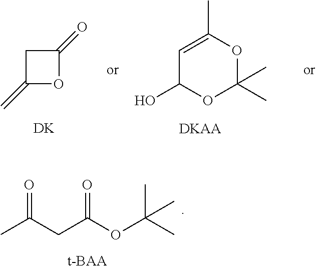

DK and DKAA are important acetoacetylation agents that find wide utility and are suitable for use in the invention.

Both DK and DKAA have some issues with their long term stability which can make transport more challenging, particularly in the case of DK. The decomposition of the active ketoester functionalization means that many acetoacetylation agents are supplied in grades that are somewhat below 100%, for instance 95%, 90%, or lower and possibly an off color.

A particularly preferred acetoacetylation agent is t-BAA. Other alkyl acetoacetates may also be used in the present invention; for example, methyl, ethyl, n-propyl, iso-propyl, or n-butyl, t-pentyl acetoacetate. When an alkyl acetoacetate is used as the acetoacetylation agent, it is an optional aspect of the invention that the reactor is designed to vent the eliminated alcohol from the system.

Prior to use, the acetoacetylation agent may optionally be purified to promote a more efficient reaction and/or to obtain a purer end product. Suitable purification methods are known in the art. By way of example, DKAA may be purified by dissolution in acetone, followed by the addition of a hydrocarbon solvent such as hexane to precipitate some or all of the impurities as a solid, allowing pure DKAA to be separated and concentrated. Alternatively, the acetoacetylation agent may be purified by distillation.

It is commonly believed in the art that the reaction of DKAA and alcohols proceeds via an acetylketene intermediary, with the elimination of acetone (see, e.g., Acetic Acid and its Derivatives, edited by Victor H. Agreda and Joseph R. Zoeller, Marcel Dekker Inc., New York, USA). The resulting acetylketene exists in equilibrium with DKAA, as such we predicted that the presence of excess acetone might have a stabilising effect on the DKAA slowing the formation of acetylketene and the rate of acetoacetylation. The inventors discovered that better results are generally obtained when the acetone is allowed to leave the reactor system used to acetoacetylate the polymer. When DKAA is used as the acetoacetylation agent, it is a preferable aspect of the invention that the reactor is allowed to vent any generated acetone.

t-BAA is an example of a particularly preferred alkyl acetoacetate acetoacetylation agent. Many alkyl acetoacetates may be used as facile acetoacetylation agents and as such offer potential in the functionalization of the polymer with ketoester groups. They form ketoester groups by a transacetoacetylation process, with the formation of an alcohol which may establish an equilibrium with the reactants. In the case of t-BAA the process thus results in the elimination of tert-butanol. As an alternative to t-BAA any other alkyl acetoacetate such as methyl, ethyl, n-propyl, iso-propyl, or n-butyl, t-pentyl acetoacetate for instance may be used. Sterically hindered esters such as t-butyl or t-pentyl (synonym t-amyl) groups react significantly faster than do less sterically hindered esters such as methyl or ethyl acetoacetate, but dependant on the identity of the alcohol may generate an alcohol by-product with a higher boiling point. When an alkyl acetoacetate is used as the acetoacetylation agent, it is an optional aspect of the invention that the reactor is designed to vent the eliminated alcohol from the system.

In a preferred embodiment, the ketoester-containing functional group comprises the moiety —O(CO)CH—C(CH₃)═O. By way of example, a ketoester functionalized poly(vinyl alcohol) (PVOH-KE) may be prepared in accordance with the process of the invention, as follows:

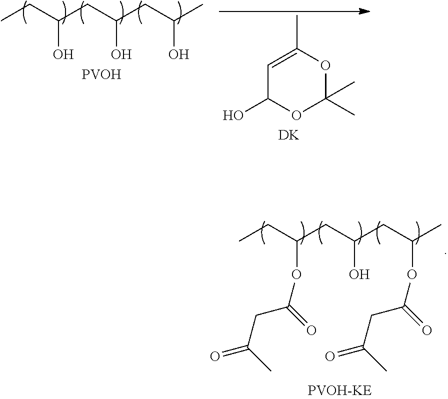

Alternatively, a ketoester functionalized ethylene-vinyl alcohol copolymer (EVOH-KE) may be prepared in accordance with the process of the invention, as follows:

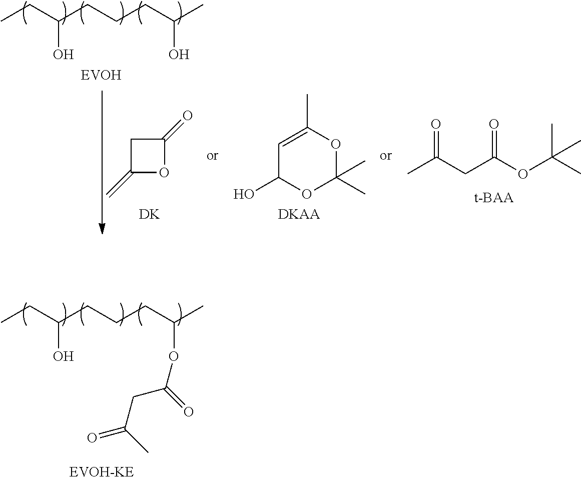

Ketoester-functionalized homo- and copolymers of vinyl alcohol of the type prepared in step (c) may also be prepared using alternative known methodologies. In one embodiment, a suitable alkene containing monomer with an acetoacetate group may be grafted onto a vinyl alcohol copolymer by means of a radical mechanism. For example, acetoacetoxyethyl methacrylate (AAEM), which is commercially available from the Eastman Company, may be combined with the vinyl alcohol polymer and a suitable radical initiator such as an azo or peroxide compound in solution or dispersion. Alternatively, the suitable alkene containing monomer with an acetoacetate group may be copolymerized with vinyl acetate or another vinyl ester and the resulting polymer selectively hydrolysed. Such methodologies constitute alternative embodiments of the process of the present invention.

According to step (d) of the process, the homo- or copolymer of vinyl alcohol comprising one or more reactive coupling groups obtained in step (c), for example EVOH-KE or PVOH-KE, is reacted with a suitable aminosilane and/or an aminosilanol. The amino group on the aminosilane reacts with the reactive coupling group on the polymer backbone, such as the ketoester group, in order to form a secondary amine, for example as follows:

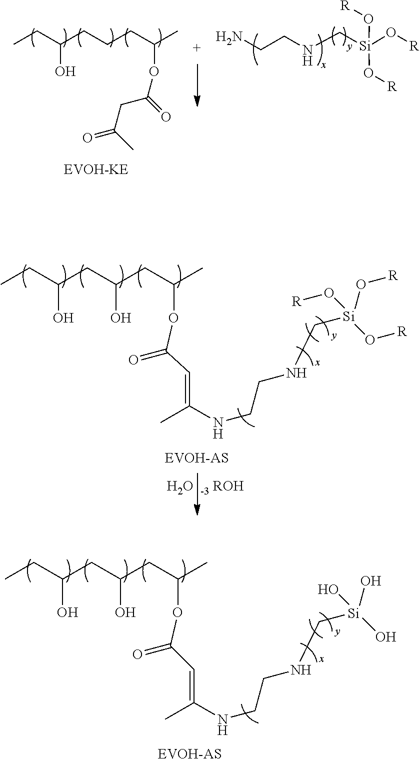

The aminosilane may be used in unhydrolysed form or may be allowed to hydrolyse in water prior to addition to the polymer. Preferably, the solvent used in step (d) is one that the polymer backbone and resulting aminosilane functionalized polymer has good solubility in such as water or dipolar aprotic solvents including DMF or DMSO. In a preferred embodiment, the reaction is performed in a mixture of one or more such solvents and another miscible solvent such as an alcohol (for example, methanol, ethanol, n-propanol or iso-propanol, preferably n-propanol). In one embodiment, there is provided a composition comprising a functionalized poly(vinyl alcohol) or vinyl alcohol copolymer of the invention and water or a mixture of water and a C₁₋₄ alcohol. Such compositions are preferably free from acid catalysts and may be used to prepare coatings containing the functionalized homo- and copolymers of vinyl alcohol of the present invention.

The aminosilanes and aminosilanols employed in the present invention are commercially available and/or may be prepared by conventional synthetic methods.

3-aminopropyltrimethoxy silane is commercially available from the Sigma-Aldrich corporation, from Power Chemical Corporation under the trade name PC1110™, and from Onichem under the trade name A301™.

3-aminopropyl triethoxysilane is commercially available from the Sigma-Aldrich corporation, from Wacker Chemie under the trade name GENIOSIL GF 93™, and from Gelest under the trade name SIA0610.0™.

N-(2-aminoethyl)-3-aminopropyl trimethoxysilane is commercially available from Evonik under the trade name DYNASYLAN DAMO™ and from Dow Corning under the name Z-6094 SILANE™.

3-[2-(2-aminoethylamino)ethylamino]propyl trimethoxysilane is commercially available from UCT under the trade name T2910™ and from Evonik under the trade name DYNASYLAN TRIAMO™.

3-[2-(2-Aminoethylamino)ethylamino]propyl triethoxysilane is commercially available from Tianjin Zhongxin.

3-Aminopropylmethyl dimethoxysilane is commercially available from the Power Chemical Corporation under the trade name SISIB PC1130™.

Upon addition of the aminosilane to a solution of polymer (backbone), it is frequently observed that a rise in viscosity occurs which can undesirably result in the gelation of the system. It has been found that typically the intensity of gelation is greater with increasing amounts of ketoester and aminosilane. Without being bound by theory, this gelation is believed to be a result of complexation of the polymer backbone, aminosilane, and/or the product of reaction of the two, or some intermediary species.

Surprisingly, it has been found that the maximum viscosity encountered in the process and therefore degree of gelation in the process can be greatly managed by control of some of the process variables. Thus, in a preferred embodiment, step (d) of the process is performed by adding either a solution of homo- or copolymer of vinyl alcohol comprising one or more reactive coupling groups, or more preferably, the polymer in solid form, to a solution of a suitable aminosilane and/or an aminosilanol. In a further preferred embodiment, the reaction mixture obtained following step (d) of the process is heated to a temperature in the range from about 0 to about 100° C., preferably in the range from about 40 to about 95° C., and more preferably in the range from about 60 to about 90° C. In still a further preferred embodiment, the reaction mixture obtained following step (d) is treated with an acid, for example a mineral acid such as HCl or an organic acid such as acetic acid. In yet a further preferred embodiment, the reaction mixture obtained following step (d) is treated with carbon dioxide. Optionally, step (d) may be performed under an inert gas such as nitrogen.

The functionalized vinyl alcohol polymers of the present invention may be optionally isolated from solution by conventional means, for example by evaporation or spray drying.

In an alternative embodiment, the aminosilane and/or aminosilanol may be combined with the functionalized polymer backbone in the absence of a solvent such as water. By way of example, the ketoester functionalized homo- or copolymer of vinyl alcohol may be mixed with the aminosilane in the absence of a solvent at an elevated temperature at which the polymer may be a melt. It will be appreciated by those skilled in the art that this process may be performed using any piece of equipment that is capable of providing sufficient mixing. These may include reactors or other vessels where agitation is provided by an overhead stirrer, a magnetic stirrer, most preferably mixing is achieved using an appropriate an extruder, z-blade mixer, batch mixer, U trough mixer, RT mixer, compounder, internal mixer, Banbury type mixer, two roll mill, Brabender type mixer, a wide blade mixer (or hydrofoil blade mixer), horizontal (delta or helical) blade mixer, kneader-reactor, or a related variation of one of these mixers such as such as a double z-blade mixer or twin screw extruder. As an alternative to carrying out the reaction with the polymer dispersed in a media it is not soluble in. Any heat introduced to the system may be supplied by conventional means or from microwave radiation.

According to further aspect of the present invention, there is provided a functionalized homopolymer or copolymer of vinyl alcohol obtainable by or obtained by the above-mentioned process.

The functionalized homo- and copolymers of vinyl alcohol of the present invention contain one of more silanol (Si—OH) groups. It is known that the silanol groups of aminosilanes may crosslink to form a Si—O—Si network, according to the following general equation:

2T-Si(T₂)-OH→T-Si(T₂)-O—Si(T₂)-T+H₂O

wherein T is any appropriate functional group such as alkyl, H, OH or alkoxy.

Cross-linking of this type can be useful in the preparation of protective (barrier) coatings since the resulting polymers typically offer increased resistance to abrasion, particularly in the presence of solvents in which the polymer is soluble. However, it has previously been suggested that the addition of an acid catalyst under heating is required to effect substantial cross-linking. The use of such catalysts can negatively affect the resulting coating in terms of their performance (any free acid may lead to a reduction in barrier performance) or aesthetic appearance from a visual or odorous perspective.

It has now surprisingly been found that homo and copolymers of vinyl alcohol when functionalized with certain aminosilanes of general formula (III) readily crosslink upon heating to form resistant coatings without the addition of an acid catalyst. Formula (III) is as follows:

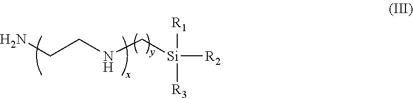

wherein,

R₁, R₂ and R₃ are as hereinbefore defined with reference to formula (IIA);

x is in the range from 2 to 9, preferably x is 2; and

y is in the range from 3 to 9, preferably y is 3.

Accordingly, in a further aspect of the present invention, there is provided a process for preparing a cross-linked polymer coating, which process comprises heating a polymer containing more than one aminosilane and/or aminosilanol side-chain of formula (III) in the absence of an acid catalyst. Preferably, the polymer is of formula P—(R)ₙ, where P is as defined above, and R is derived from an aminosilane or aminosilanol of formula (III) as described above. Preferably, the polymer is heated to a temperature of from about 80 to about 120° C., more preferably to about 100° C. Preferably, the polymer containing more than one amino side-chain of formula (III) has a backbone P that is a straight or branched chain homopolymer or copolymer of vinyl alcohol of the type defined in formula (I) herein. The present invention also provides a cross-linked polymer coating obtainable from such a process.

The functionalized homo- and copolymers of vinyl alcohol of the present invention may be used in a wide variety of commercial applications in which they may form, or are a component of, a film or layer. These will include various coatings applications including inks and adhesives, including for instance in architectural, decorative, industrial, automotive, aeronautical, maritime, protective and functional coatings; inks for news and magazine print, printing solutions for home and commercial use; adhesives or sealants for consumer and industrial use. It will be understood that there are many forms and methods for the delivery of such coatings, for instance architectural coatings for home and industrial use may be applied in the form of a paint or alternatively may be distributed from a multifunctional formulation designed to clean a surface and apply a coating. The coating may be applied to the body of a human or other animal, for instance a cosmetic or medicament. The adhesive may also take the form of a coating between two surfaces acting as a sealant in a mechanical assembly for instance. The polymer may act as a binder in formulations of the type described herein. In a preferred embodiment there is provided the use of a functionalized homo- or copolymer of vinyl alcohol of the invention as a coating in a composite film structure. There is also provided a coating comprising a functionalized homo or copolymer of vinyl alcohol according to the invention. It will be appreciated that coating compositions comprising functionalized homo- and copolymers of vinyl alcohol of the present invention may optionally include a number of other components appropriate to the application of the composition including by way of non-limiting example pigments, preservatives, wetting agents, surfactants, dispersants open time extenders and the like.

The above-described novel functionalized polymers may be used in ink and coating compositions. Such ink and coating compositions are useful in packaging applications. The ink and coating compositions generally are defined as being gas barrier coatings especially for withstanding permeation of oxygen. The terms “inks” and “coatings” are both used in the present application. Applicants wish to make it clear that the present application is meant to encompass both inks and coatings, even if it is not explicitly stated as such in the text. The coating compositions disclosed herein comprise one or more functionalized homopolymers and copolymers of vinyl alcohol, and one or more aminosilane-containing and/or aminosilanol-containing side chains attached to the polymer backbone via a reactive coupling group.

The ink or coating composition is suitable for use in rigid, flexible food and industrial packaging. The polymer of the coating composition may further contain a monomer such as an olefin, vinylic monomer, acetoacetoxyethyl, methacrylates, diacetone acrylamides and combinations thereof. In another embodiment, the coating composition may include functionalized homopolymers and copolymers in addition to filler particles. The filler may be inorganic. The filler may also include high aspect ratio minerals. The fillers are generally dispersed in the coating composition, e.g., barrier layer, in an amount to show enhancement of the oxygen barrier property compared with coating compositions free of such fillers.

One of the many benefits of the instant ink and coating compositions in relation to those known in the art is the PVOH/EVOH polymer backbones bearing the silane-functionality achieved by imine formation between the pendant keto-ester group and aminosilane. As provided in more detail below, the compositions exhibit excellent laminate bond strength at low and high humidity, e.g., moisture levels, when applied onto a range of flexible plastic films. Yet another advantage of coating compositions according to the present invention is maintaining bond strengths even when immersed in a body of water. According to the inventors, it is understood the ink and coating compositions described in the present invention are barrier layers formed by reacting a functionalized homopolymer, copolymer or a combination thereof of vinyl alcohol of formula (I), as disclosed above.

There is no restriction on the nature of polyvinyl alcohol or ethylene-vinyl alcohol copolymer employed. Preferably, the degree of saponification should be greater than 70%, preferably more than 90%, and even more preferably more than 95%. In a preferred embodiment, the degree of saponification should be: 70%; 71%; 72%; 73%; 74%; 75%; 76%; 77%; 78%; 79%; 80%; 81%; 82%; 83%; 84%; 85%; 86%; 87%; 88%; 89%; 90%; 91%; 92%; 93%; 94%; 95%; 96%; 97%; 98%; 99%; and 100%.

Particularly preferred are copolymers of ethylene and vinyl alcohol with concentrations less than about 40 mol %. Especially preferred copolymers have less than about 30 mol %, and even more preferred are those having less than about 20 mol %. Commercially available polymers of this type include the EXCEVAL range from Kuraray.

In another exemplary embodiment, the concentration is less than: 39%; 38%; 37%; 36%; 35%; 34%; 33%; 32%; 31%; 30%; 29%; 28%; 27%; 26%; 25%; 24%; 23%; 22%; 21%; 20%; 19%; 18%; 17%; 16%; 15%; 14%; 13%; 12%; 11%; 10%; 9%; 8%; 7%; 6%; 5%; 4%; 3%; 2%; and 1%.

In an exemplary embodiment thereof, the ink or coating composition comprises a polymer or copolymer such as PVOH and/or an EVOH, and acetoacetate reactive coupling group(s). The acetoacetate groups have been partially or fully reacted with amino silane and/or aminosilanol side chains attached to the backbone of the copolymer such as functional alkoxy silane. In a further exemplary embodiment, the coating composition includes a dispersed clay.

The inks and coatings have a solids content which exhibit viscosities suitable for gravure or flexographic printing. The viscosity of the inks or coatings can also be adjusted to allow for other coating processes. The solids content is generally made up of the amount of functionalized polymer including at least the total amount of silane-functional PVOH and/or EVOH, and any optionally added polymers, and any optionally added fillers. The concentration of filler and polymer in the solution will depend on at least the following: (i) solubility/dispersability; (ii) manner in which the coating is applied, e.g., gravure, flexo, curtain coating, roll coating, dip coating, spray, etc.; and (iii) the amount of solvent employed with the minimum needed to achieve sufficient flowability to adequately coat the substrate.

The overall solids content of the ink or coating composition ranges from about 0.5 to 15% (w/w). The solids content of the coating composition may preferably be about 2 to 8%. The solids content in (w/w) may be 0.5%; 1%; 1.5%; 2%; 2.5%; 3.0%; 3.5%; 4.0%; 4.5%; 5.0%; 5.5%; 6.0; 6.5%; 7.0%; 7.5%; 8.0%; 8.5%; 9.0%; 9.5%; 10.0%; 10.5%; 11.0%; 11.5%; 12.0%; 12.5%; 13.0%; 13.5%; 14.0%; 14.5%; and 15.0%.

In yet another embodiment, about 30 to 95% (w/w) of the total solids content includes the functionalized polymer, the remainder being constituted of the mineral filler and any other components. Preferably, the range is about 40 to 75% (w/w). More preferably, the range is about 50 to 75% (w/w). The solids content (w/w) based on the total clay may be: 30%; 31%; 32%; 33%; 34%; 35%; 36%; 37%; 38%; 39%; 40%; 41%; 42%; 43%; 44%; 45%; 46%; 47%; 48%; 49%; 50%; 51%; 52%; 53%; 54%; 55%; 56%; 57%; 58%; 59%; 60%; 61%; 62%; 63%; 64%; 65%; 66%; 67%; 68%; 69%; 70%; 71%; 72%; 73%; 74%; 75%; 76%; 77%; 78%; 79%; 80%; 81%; 82%; 83%; 84%; 85%; 86%; 87%; 88%; 89%; and 90%.

According to the inventors, carefully controlling the ratio of either/both reactive coupling groups, i.e., ketoester groups, to the polymer backbone, and the aminosilane side chains to reactive coupling groups, results in superior adhesion characteristics, at various moisture levels contingent upon temperature and humidity, of the coating or ink composition when applied onto a predetermined substrate. Such results are assessed in view of coatings free of aminosilane functionalization.

In yet another exemplary embodiment, there is disclosed a process for preparing the ink and coating compositions of the present invention. The compositions are produced by preparing aqueous solutions or dispersions of copolymers having a polyvinyl alcohol (PVOH), or ethylene vinyl alcohol (EVOH) polymer backbone (P), containing reactive coupling groups such as acetoacetyl groups which have been reacted with an alkoxy silane side chain (R) attached to the backbone of the copolymer having an amino group.

To produce the barrier coatings of the current invention, aqueous solutions of the silane-functional PVOH/EVOH are prepared, and then mixed with aqueous dispersions of clay. The silane-functional PVOH/EVOH is dissolved in an aqueous solvent, which may contain a water-miscible co-solvent. Preferred co-solvents are alcohols, in particular ethanol, n-propanol and iso-propanol. The term “aqueous solvent” as used herein, encompasses pure water and mixtures comprising water and one or more water-miscible co-solvents. Preferably, water constitutes the major part, for example at least 50% w/w of the aqueous solvent. Preferably, a water-miscible co-solvent constitutes less than 50% w/w of the solvent blend. More preferably, the co-solvent constitutes a maximum of 30% w/w of the total solvent blend (most preferably 5-30% w/w of the total solvent blend) and less than 20% w/w of the total formula.

It will be appreciated that the reaction process may be performed using any equipment capable of providing sufficient mixing. These may include reactors or other vessels where agitation is provided by an overhead stirrer, a magnetic stirrer, most preferably mixing is achieved using an appropriate extruder, z-blade mixer, batch mixer, U trough mixer, RT mixer, compounder, internal mixer, Banbury type mixer, two roll mill, Brabender type mixer, a wide blade mixer (or hydrofoil blade mixer), horizontal (delta or helical) blade mixer, kneader-reactor, or a related variation of one of these mixers such as such as a double z-blade mixer or twin screw extruder. Heat introduced to the system may be supplied by conventional means or from microwave radiation.

As previously mentioned, the preparation of keto-ester reactive coupled PVOH/EVOH of functional polymers is well known and is achieved by reacting the parent PVOH/EVOH with, for example, diketene or other suitable agent, such as the diketene-acetone adduct as depicted in (2):

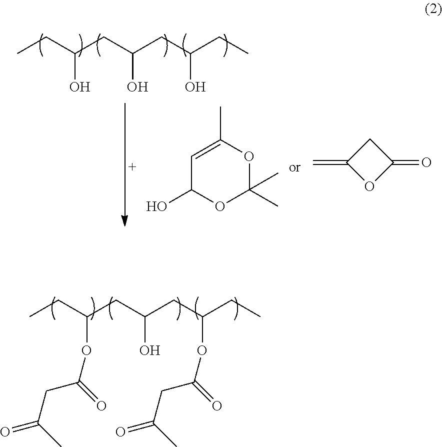

Polymers of this type are commercially available; the Gohsefimer range from Nippon Gohsei being a typical example.

These keto-ester reactive coupled or functional PVOH/EVOH polymers are readily reacted via their pendant carbonyl groups with aminosilanes. Scheme (3) below illustrates this, for the reaction between a keto-ester functional PVOH with [3-(2-aminoethylamino)propyl]trimethoxysilane, resulting in the desired imine adduct. Since the reactions are normally carried out in aqueous solutions, concurrent hydrolysis of the alkoxy silane will also likely occur and this is also shown in (3):

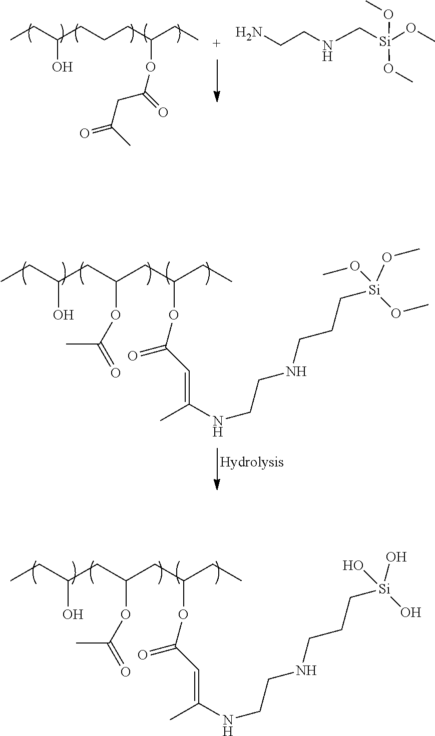

The preferred ratio of aminosilane used to react with the keto-ester reactive coupled or functional PVOH/EVOH polymer or copolymer is in the range of 1:2 to 1:100 based upon the relative weights of the 2 reagents. By this, we mean that the preferred ratio is 1 part of an aminosilane to between 2 and 100 parts of the keto-ester functional PVOH/EVOH. A more preferred aminosilane:keto-ester functional PVOH/EVOH ratio is between 1:2 and 1:20. In an exemplary embodiment, the ratio is: 1:2; 1:3; 1:4; 1:5; 1:6; 1:7; 1:8; 1:9; 1:10; 1:11; 1:12; 1:13; 1:14; 1:15; 1:16; 1:17; 1:18; 1:19; 1:20; 1:21; 1:22; 1:23; 1:24; 1:25; 1:26; 1:27; 1:28; 1:29; 1:30; 1:31; 1:32; 1:33; 1:34; 1:35; 1:36; 1:37; 1:38; 1:39; 1:40; 1:41; 1:42; 1:43; 1:44; 1:45; 1:46; 1:47; 1:48; 1:49; 1:50; 1:51; 1:52; 1:53; 1:54; 1:55; 1:56; 1:57; 1:58; 1:59; 1:60; 1:61; 1:62; 1:63; 1:64; 1:65; 1:66; 1:67; 1:68; 1:69; 1:70; 1:71; 1:72; 1:73; 1:74; 1:75; 1:76; 1:77; 1:78; 1:79; 1:80; 1:81; 1:82; 1:83; 1:84; 1:85; 1:86; 1:87; 1:88; 1:89; 1:90; 1:91; 1:92; 1:93; 1:94; 1:95; 1:96; 1:97; 1:98; 1:99; and 1:100.

In an alternative embodiment, the aminosilane:keto-ester functional PVOH/EVOH ratio may equimolar, or fairly close thereto. For examples, the ratio may be 2:1 to 1:100. More preferably, the ratio is 2:1 to 1:10. Even more preferably, the ratio is 1.5:1 to 5:1.

In yet another exemplary embodiment, there is described a laminated package including the above-mentioned ink or coating compositions. In one embodiment, the laminate is used for food packaging. For example, the food packaging may be for chilled or frozen foods. The food packaging may also be for foods stored at room temperature such as potato chips. In another embodiment, the laminate is used in industrial packaging, for example, cosmetics and pharmaceuticals. According to the inventors, such laminates provide surprising results with respect to laminate bond strength and oxygen barrier properties, particularly in high humidity environments.

One of the many benefits of the laminated package is the application of the ink or coating composition onto a broad range of plastic films, e.g., substrates, without requiring a primer layer. Thus, one laminate including the inventive ink or coating composition applied thereon may subsequently be fixed or to another laminate and still deliver bond strengths under varied conditions such as low and high humidity, water immersion, etc. Moreover, the laminated package in view of the ink and coating compositions exhibit excellent gas barrier performance even in high humidity environments. According to one of the experiments, the inventive inks and coatings achieve better characteristics when compared to a coextruded EVOH structure, at relative humidity (RH) greater than about 50%. Another advantage is the inventive inks and coatings do not require chlorinated materials. Hence, the toxicity concern associated with a conventional PVDC is overcome

The ink or coating composition of the present invention also has been found suitable for use with flexible plastic film substrates. Flexible plastic film substrates generally have poor inherent oxygen barrier properties likely attributed to its elasticity characteristics. Generally, a laminate material, having no gas barrier layer, would typically has an oxygen transmission rate (OTR) of at least 50 cm³/m²/day at 23° C. and 80% RH, especially at least 80 cm³/m²/day at 23° C. and 80% RH, and in some cases at least 1000 cm³/m²/day at 23° C. and 80% RH). On the other hand, when the novel ink and coating compositions are applied to one or more plastic film substrates, significantly improved gas barrier properties are observed even at increased relative humidity. For example, a preferable oxygen barrier is one of less than 20 cm³/m²/day, and even more preferable is an oxygen barrier of less than 10 cm³/m²/day, at 23° C. and 80% RH.

In yet even a further exemplary embodiment, there is described a process for preparing laminated packages. An adhesive layer may directly be applied to a surface of a substrate. An ink or coating composition may be applied to a surface of another substrate. Alternatively, the adhesive layer may be applied onto the ink or coating on the surface of the plastic film. In one exemplary embodiment, the laminated package includes the gas barrier coating; an adhesive; and another plastics film. In another exemplary embodiment, additional layers composed of other materials may be interposed between any of the layers. In yet another exemplary embodiment, additional layers may formed on either side of the two flexible plastic film substrates having the ink or coating composition therebetween.

According to another aspect of the present invention, the ink and coating compositions may include fillers. The fillers may include but are not limited to the following: talc, calcium carbonate, barium sulfate, wollastonite, mica, clay, kaolin, silica, diatomaceous earth, alumina, zinc white, magnesium oxide, calcium sulfite, calcium sulfate, calcium silicate, barium sulphate, glass powders and combinations thereof. Particularly preferred fillers are clays.

The clay compound is advantageously one which disperses readily in aqueous media, a high degree of exfoliation of the mineral lamellae being required to provide the maximum barrier performance. The clay used is preferably a nanoparticulate. A nanoparticulate clay is a clay with particles having at least one dimension in the nanometer range, i.e., of less than 100 nm. Typically, nanoparticulate clay particles have a maximum thickness dimension of less than 100 nm, for example a maximum dimension of less than 50 nm, such as a maximum dimension of less than 20 nm.

There is no restriction on the type of clay used in embodiments provided that it is sufficiently dispersible in an aqueous medium, it is capable of being intercalated or exfoliated during dispersion and/or it is suitable for use in an oxygen barrier coating. In an exfoliated form, the aspect ratio of the clay, i.e., the ratio between the length and thickness of a single clay ‘sheet’, will have an impact on the level of oxygen barrier achieved. The greater the aspect ratio, the more the rate of oxygen diffusion through the dry coating and laminate will be reduced. Advantageously, the clay has an aspect ratio greater than about 20 in its exfoliated form. Clay minerals with aspect ratios between 20 and 10,000 are typically used. Particularly preferred are those minerals having an aspect ratio greater than about 50 for example greater than about 100, and more particularly greater than 250.

Examples of suitable clays include kaolinite, montmorillonite, atapulgite, illite, bentonite, halloysite, kaolin, mica, vermiculite, diatomaceous earth and fuller's earth, calcined aluminum silicate, hydrated aluminum silicate, magnesium aluminum silicate, sodium silicate and magnesium silicate. These materials may be used alone or in combinations. Particularly preferred clays are those of the vermiculite family. Commercial examples of suitable materials are available as pre-made dispersions, such as the MICROLITE range from W.R. Grace. In a preferred embodiment, the clay is a vermiculite.

According to the inventors, the above-described clays in combination with the novel silyl-functional polymers exhibit improved bond strength while maintaining good barrier performance even in high relative humidity. The results are provided in more detail below.

In yet another aspect of the present invention, the ink and coating compositions are applied onto a substrate. While there is no particular restriction on the nature of the flexible substrate, plastic polymeric films are preferred. However, where the material being packaged with the coating film of the present invention is a foodstuff or pharmaceutical, it will normally be preferred that the plastics film or other substrate is food grade.

Examples of suitable materials include: polyolefins, such as polyethylene or polypropylene; polyesters, such as polyethylene terephthalate, polybutylene terephthalate or polyethylene naphthenate; polyamides, such as nylon-6 or nylon-66; and other polymers, such as polyvinyl chloride, polyimides, acrylic polymers, polystyrenes, celluloses, or polyvinylidene chloride. It is also possible to use copolymers of any compatible two or more of the monomers used to produce these polymers. Furthermore, compositions of the present invention may be included in adhesively formed laminates comprising paper substrates, such as polyester and polyolefin coated paperboards commonly encountered in food packaging.

The substrate is preferably treated immediately prior to its being coated with the composition of the present invention, preferably by corona discharge, though other treatment methods known in the art are also acceptable. This process is well known in the art and is described, for example, in “Plastics Finishing and Decoration”, edited by Donatas Satas, published by Van Nostrand Reinhold Company in 1986, at pages 80-86. The two flexible polymer films may be the same as each other or they may be different from each other.

Exemplary food packaging applications include but not limited to MAP (modified atmosphere packaging), such as cooked (chilled) meats, cheeses, yogurts, etc. These plastic packages contain a modified atmosphere which can be controlled blends of N₂ and CO₂. Thus, oxygen is excluded from the package helping to prevent spoilage of the product by oxidation or aerobic bacterial action. Other packaging types which require a good level of oxygen barrier include savory products like potato chips and nuts. It is important to exclude oxygen from these products to slow and/or prevent the oxidation of the fats contained therein. Flexible barrier packaging is used in many more applications, including coffee packaging, wine packaging, and juice packaging.

Measured examples of PET-Al films for their oxygen barrier performance have values for oxygen transmission rates (OTR) in the range 1.0-7.5 cm³/m². One advantage of this type of film is that the oxygen barrier performance remains independent of relative humidity. However, the films are opaque and the oxygen barrier performance of these films deteriorates in view of cracks when the film is flexed.

Similarly, thin ceramic coated plastic films are also commonly used. These are either thin aluminum oxide (‘AlOₓ’) or silicon oxide (‘SiOₓ’) coated films, particularly PET. Similar to PET-Al coatings, the oxygen barrier performance of these films is independent of relative humidity, but they are also prone to flex cracking causing loss of gas barrier performance. Measured OTRs in the ranges of 2-10 and 1-6 for PET-AlOₓ and PET-SiOₓ.

Moreover, inorganic coated films require specialized high vacuum equipment for their manufacture. The instant coatings can be applied onto plastic films by conventional printing methods which makes them potentially much more versatile. Moreover, a printer does not have to stock various films, e.g., PET, PET-SiOₓ, etc, and may stock the uncoated base films, e.g., PET, and apply their own barrier coatings.

According to yet even another aspect of the present invention, an adhesive may be applied onto a substrate having the ink and coating composition as described above. There is no particular restriction on the nature of the adhesive used, and any adhesive commonly used for the adhesion of two or more plastics films may be employed in the present invention. Examples of suitable adhesives include solvent-based (polyurethane) types such as those from Henkel (LIOFOL UR3969/UR 6055, LIOFOL UR3640/UR6800, LIOFOL UR3894/UR6055), Rohm&Haas (ADCOTE 811/9L10), and Coim (CA2525/2526, NC250/CA350); Solvent-free polyurethane adhesives such as LIOFOL 7780/UR6082, UR7750/UR6071 from Henkel, and MOR-FREE ELM-415A/MOR-FREE CR140 from Rohm&Haas, can also be used. Additionally, epoxy-based adhesives such as LAMAL 408-40A/C5083 may be used. Waterborne adhesives, such as AQUALAM 300A/300D, an epoxy type from Rohm & Haas may also be used. This layer bonds the oxygen barrier layer to the protective layer or layers as described above.

Examples of the material for this layer include polar group-containing modified polyolefins obtained by graft modifying polyethylene, polypropylene, or ethylene-vinyl acetate copolymer with unsaturated carboxylic acids, or unsaturated polycarboxylic acids or anhydrides thereof; ethylene-vinyl acetate copolymer and saponification products thereof; ethylene-ethylacrylate copolymer, ethylene-acrylic acid copolymer, ethylenemethacrylic acid copolymer, ionomers obtained by crosslinking such copolymers with metallic ions; and block copolymers of styrene with butadiene. These are preferably synthetic resins compatible with synthetic resins used for forming the oxygen barrier layer and the protective layers.

### EXAMPLES

### PVOH-KE Series

Materials

MOWIOL™ 4-98 (M4-98™) and EXCEVAL™ AQ-4104 (AQ-4104™) was obtained from Kuraray and used as supplied. GOHSENOL™ GH-17R (GH-17R™) was supplied by Nippon Gohsei and used as supplied. The viscosity of PVOH grades is typically expressed in MPas, measured by recording the relevant value of a 4% solution maintained at 20° C. using a Brookfield viscometer. M4-98™ is a poly(vinyl alcohol) with a viscosity of 4.0-5.0 MPas and a 98.0-98.8% degree of hydrolysis. AQ-4104™ is a copolymer of vinyl alcohol (85-90 mol %) and ethylene (10-15 mol %) with a viscosity of 3.8-4.5 MPas and a 98.0-99.0% degree of hydrolysis. GH-17R™ is a poly(vinyl alcohol) with a viscosity of 27-33 MPas and a 86.5-89.0% degree of hydrolysis.

3-Aminopropyltrimethoxysilane (APMES) and 3-Aminopropyltriethoxysilane (APTES) were obtained from Sigma-Aldrich and used as supplied. N-(2-Aminoethyl)-3-aminopropyl-trimethoxysilane (ETAPMS, was obtained from Evonik under the trade name Dynasylan™ DAMO. 342-(2-Aminoethylamino)ethylamino]propyl-trimethoxysilane (DETAPMS) was obtained from UCT as T2910 and used as received. 3-[2-(2-Aminoethylamino)ethylamino]propyl-triethoxysilane (DETAPES) was obtained from Tianjin Zhongxin and used as received.

Anhydrous dimethyl sulfoxide (DMSO) and acetic acid were used as supplied by Sigma Aldrich. Acetone was of a standard laboratory grade and used without further preparation. 2,2,6-trimethyl-4H-1,3-dioxin-4-one (diketene acetone adduct, DKAA) was purchased from Sigma Aldrich, Lonza quality (>93.0%) or Aldrich (>95.0%) and purified before use by the method outlined below. Diketene (DK) and tert-butyl acetoacetate (t-BAA) were obtained from Sigma Aldrich and used as received.

Process for the Purification of DKAA

DKAA is supplied by Sigma Aldrich as a dark brown liquid. Before use in the ketoester grafting process, impurities were removed from DKAA by selective precipitation to prevent contamination of the polymers with the brown coloured impurities.

Hexane (2 L) was charged to a large beaker. DKAA (100 g, 0.703 mol) was added to the beaker, with agitation from an overhead stirrer equipped with a PTFE anchor stirrer shaft. DKAA is immiscible with hexane.

Acetone was added dropwise until the solution turned yellow and a small amount brown tar settled at the bottom of the beaker. The solution was decanted into a clean beaker, leaving the oil behind which was then discarded. The solution was then passed through a Buchner filter and transferred to a pear-shaped Buchi flask. Hexane and acetone were removed from the solution by rotary evaporation at 40° C., giving a yellow/orange liquid.

This liquid was added to a fresh portion of hexane (2 L) and the above process was repeated. After removing the hexane and acetone, the temperature of the rotary evaporator's water bath was raised to 50° C. and maintained for one hour (pressure <50 mbar) to ensure all solvent had evaporated.

Process for Synthesis of Ketoester Functionalized Polymer Backbones

PVOH-KE1

M4-98™ (60.0 g) and DMSO (540.0 g) were charged to a 1 L flange flask. The flask was fitted with an overhead stirrer equipped with a PTFE anchor stirrer shaft and placed under a blanket of nitrogen. The flask was heated with an oil bath to an external temperature of 135-145° C., allowing the M4-98™ to fully dissolve. The internal temperature of the flask was then adjusted to 120° C.

Purified DKAA (14.5 g, 0.102 mol) was added dropwise over a one hour period. One neck of the flange flask was left open to drive off the acetone produced during the acetoacetylation process. The temperature of the flask was maintained at 120° C. for a further hour, before the flask was allowed to cool to ambient temperature.

The polymer was precipitated in acetone (2×50 mL DMSO solution into 1 L acetone) and was dried under vacuum (<50 mbar) at 50° C. for 24 hours. This polymer was re-dissolved in water to give a 10 w/w % solution. The polymer was again precipitated in acetone (2×50 mL aqueous solution into 1 L acetone) and dried under vacuum (<50 mbar) at 50° C. for 48 hours.

PVOH-KE 2

Polymer was prepared by the exact same method as described for PVOH-KE1, except the loading level of DKAA was 30.0 g, 0.211 mol rather than 14.5 g, 0.102 mol.

PVOH-KE 3

Polymer was prepared by the exact same method as described for PVOH-KE1, except the loading level of DKAA was 41.6 g, 0.293 mol rather than 14.5 g, 0.102 mol.

PVOH-KE 4

M4-98 (50.0 g) and DMSO (450.0 g) were charged to a 1 L flange flask. The flask was fitted with overhead stirrer equipped with a PTFE anchor stirrer shaft and a steady nitrogen flow. The flask was heated with an oil bath to an external temperature of 135-145° C., allowing the M4-98 to fully dissolve. Internal temperature of the flask was then adjusted to 120° C.

Purified DKAA (64.5 g, 0.454 mol) was added dropwise over a one hour period. One neck of the flange flask was left open to drive off the acetone produced during the acetoacetylation process. Temperature of the flask was maintained at 120° C. for a further hour, before the flask was allowed to cool to ambient temperature.

The polymer was precipitated in toluene (600 mL DMSO solution into 2.5 L toluene) and dried under vacuum (<50 mbar) at 50° C. overnight. This polymer was re-dissolved in methanol (250 mL) and precipitated in acetonitrile (80 mL methanolic solution per 800 mL acetonitrile) and dried under vacuum (<50 mbar) for 24 hours.

PVOH-KE 5

AQ-4104 (55.0 g) and DMSO (495.0 g) were charged to a 1 L flange flask. The flask was fitted with an overhead stirrer equipped with a PTFE anchor stirrer shaft and a steady nitrogen flow. The flask was heated with an oil bath to an external temperature of 135-145° C., allowing the AQ-4104 to fully dissolve. Internal temperature of the flask was then adjusted to 120° C.

Purified DKAA (3.55 g, 0.025 mol) was added dropwise over a one hour period. One neck of the flange flask was left open to drive off the acetone produced during the acetoacetylation process. Temperature of the flask was maintained at 120° C. for a further hour, before the flask was allowed to cool to ambient temperature.

The polymer was precipitated in acetone (2×50 mL DMSO solution into 1 L acetone) and was dried under vacuum (<50 mbar) at 50° C. for 24 hours. This polymer was re-dissolved in water to give a 10 w/w % solution. The polymer was again precipitated in acetone (2×50 mL aqueous solution into 1 L acetone) and dried under vacuum (<50 mbar) at 50° C. for 48 hours.

PVOH-KE 6

Polymer was prepared by the exact same method as described for PVOH-KE5, except the loading level of AQ-4104 was 60.0 g rather than 55.0 g, the loading level of DMSO was 540.0 g rather than 495.0 g and the loading level of DKAA was 16.5 g, 0.116 mol rather than 3.55 g, 0.025 mol.

PVOH-KE 7

Polymer was prepared by the exact same method as described for PVOH-KE 6, except the loading level of DKAA was 8.30 g, 0.058 mol rather than 16.5 g, 0.116 mol.

PVOH-KE 8

Polymer was prepared by the exact same method as described for PVOH-KE 6, except the loading level of DKAA was 26.40 g, 0.186 mol rather than 16.5 g, 0.116 mol.

Used diketene to graft keto ester functionality onto the PVOH backbone. Initial aim is to functionalize 25% of the alcohol groups.

Preparation of PVOH-KE Sample Using DK

M4-98™ (5.0 g, 0.1134 moles) was dissolved in DMSO (45.0 g) at 100° C. with stirring. The flask was then cooled down to an internal temperature of 60° C. DK (2.39 g, 0.0284 moles) was added dropwise over a period of one hour. The reaction was left for 45 minutes before being cooled to ambient temperature.

The red/brown solution was precipitated in acetone (300 mL), giving a light yellow solid which was recovered by filtration. The polymer was cut up into smaller pieces and stirred in acetone (300 mL) to extract impurities, before being subsequently recovered by filtration and dried overnight under vacuum at 50° C. Finally, the polymer was then re-dissolved in distilled water at 100° C. before being re-precipitated in acetone (300 mL) and dried overnight under vacuum at 50° C.

Preparation of PVOH-KE Sample Using t-BAA

GH-17R™ (50 g) was weighed and added in to a flanged reactor flask, to which DMSO (105 g) was added, followed by t-BAA (20 g). Finally acetic acid (2.5 g) was added. The flask was equipped with an overhead stirrer and condenser and the contents placed under a blanket of nitrogen. The reaction mixture was then agitated and heated by means of an oil bath maintained at 130° C. for 3 hours. After this time the reaction mixture was allowed to cool to ambient temperature. It was then precipitated into acetone by adding it in two equally sized aliquots to acetone (1 L), the precipitate formed from the first aliquot being filtered off by vacuum filtration prior to addition and subsequent filtration of the second aliquot. The resulting white fibrous product was dried overnight under vacuum at 50° C.

Functionalization with Aminosilane

A stock solution of APTES was created simply by adding the aminosilane to water with agitation and leaving the mixture for a minimum of 24 hours. This solution was then utilised in the following example formulation:

| | % w/w |
|---|---|
| 1. Deionised Water | 56.59 |
| 2. 25% w/w APTES (water solution) | 8.55 |
| 3. PVOH-KE6 | 7.86 |
| 4. Ethanol | 27.00 |
| | 100.0 |

The aminosilane and PVOH-KE6 were then mixed together in one of two different methods as outlined below.

Method A—without pH Modification:
Add 1 and 2 to mixing vessel and stir to create a homogenous solution of pH 11. Add 3 with sufficient stirring to prevent the formation of lumps.
After between 2 to 5 minutes the mixture will start to gel, at this point turn off the stirrer.
Turn on heat source, take to internal temp of approximately 90° C. and allow to stand, while heating. After a period of roughly 15 to 30 minutes liquid will be seen as the gel begins to collapse.
At this point re-start stirrer (slowly, at first) and if practicable break up gel with agitation (accomplished on a lab scale using a spatula or suchlike) to help speed up the final collapse of the gel.
Keep stirring and heating until gel has fully collapsed.
When fully dissolved reduce internal temperature to approx. 70° C.
Then add 4 slowly under stirring.
Leave to stir for 10 minutes, and then cool to ambient.

Method B—Methodology Using Carbon Dioxide:

The basic formulation method has been modified to include carbon dioxide gas. The CO₂ gas was added to generate carbonic acid in situ to prevent or control the gelation process. With the exception of the carbon dioxide added in an attempt to control the viscosity of the process it remains essentially similar to that of the basic method A.
1 and 2 were added to a mixing vessel and stirred to create a homogenous solution. CO₂ was then bubbled in via a glass sinter at 1 L/minute through the solution, resulting in a reduction in pH from pH11 down to pH7. The passage of gas was continued during the manufacture of the formulation in an attempt to maintain a pH of 7.
The acetoacetylated polymer (3) is then added to the formulation with sufficient agitation to prevent agglomeration. Stirring is continued to dissolve the polymer but it will become necessary to increase the temperature to completely dissolve the polymer. During the process of heating it seems the loss of carbon dioxide from the solution allows at least some degree of gelation to occur. It is our finding that if the resulting lumps can be kept mobile at elevated temperature then it is possible to stir the mixture until the viscosity decreases. Ethanol (4) would then be added in a similar manner to that described in A.

It is possible to prepare a range of aminosilane functionalized homo and copolymers in accordance with the present invention by modifying the ratio of the aminosilane or by replacing APTES with APMS, ETAPMS, DETAPMS or DETAPES for example of by using an alternative ketoester functionalized PVOH.

### Experimental Results

A series of ketoester functionalized homo- and copolymers of vinyl alcohol were prepared by reaction of DKAA and various vinyl alcohol homo- and copolymers, as follows:

TABLE 1

| | | Backbone | DKAA | DMSO |
|---|---|---|---|---|
| Material | Backbone | Amount (g) | Amount (g) | Amount (g) |
| PVOH-KE1 | M4-98 | 60 | 14.5 | 540 |
| PVOH-KE2 | M4-98 | 60 | 30 | 540 |
| PVOH-KE3 | M4-98 | 60 | 41.6 | 540 |
| PVOH-KE4 | M4-98 | 50 | 64.5 | 450 |
| PVOH-KE5 | M4-98 | 55 | 3.55 | 495 |
| PVOH-KE6 | AQ-4104 | 60 | 16.5 | 540 |
| PVOH-KE7 | AQ-4104 | 60 | 8.3 | 540 |
| PVOH-KE8 | AQ-4104 | 60 | 26.4 | 540 |

MOWIOL ™ 4-98 (M4-98 ™) is a PVOH sold by Nippon Gohsei and AQ-4104 ™ is an EVOH sold by Kuraray.

In addition, a series of compositions were prepared by reaction of certain aminosilanes with commercially sourced ketoester functionalized polymers, or from vinyl alcohol homo- and copolymers that were subsequently functionalized by means of an acetoacetylation agent, as follows:

TABLE 2

| | Estimate of | | PVOH | | | | |
|---|---|---|---|---|---|---|---|
| | KE (mol %) | | Conc. | | | | |
| | on PVA and | | Weight | | Cross- | Conc. | |
| Sample Name | Backbone | | % | Solvent | linker | (mol %) | Acidified |
| PVOH AS-1A | 4.4 | (Z-200) | 5 | Water | DETAPMS | ~5 | No |
| PVOH AS-1B | 4.4 | (Z-200) | 5 | Water | DETAPMS | ~10 | No |
| PVOH AS-1C | 4.4 | (Z-200) | 10 | Water | DETAPMS | ~5 | No |
| PVOH AS-1D | 4.4 | (Z-200) | 10 | Water | DETAPMS | ~10 | HCl |
| PVOH AS-1E | 4.4 | (Z-200) | 10 | Water | DETAPMS | ~10 | No |
| PVOH AS-1F | 4.4 | (Z-200) | 10 | Water | DETAPMS | ~10 | CH₃CO₂H |
| PVOH AS-1G | 0 | (M4-98) | 10 | Water | DETAPMS | ~10 | No |
| PVOH AS-1H | 8.4 | (O3551) | 10 | Water | DETAPMS | 50 | No |
| PVOH AS-1I | 4.4 | (Z-100) | 10 | Water | DETAPMS | ~5 | No |
| PVOH AS-1J | 4.4 | (Z-200) | 15 | Water | DETAPMS | ~5 | No |
| PVOH AS-2A | ~5 | (M4-98) | 10 | Water | DETAPMS | 20 | HCl |
| PVOH AS-2B | ~5 | (M4-98) | 10 | Water | DETAPMS | 80 | HCl |
| PVOH AS-2C | ~10 | (M4-98) | 10 | Water | DETAPMS | 50 | HCl |
| PVOH AS-2D | ~20 | (M4-98) | 10 | Water | DETAPMS | 20 | HCl |
| PVOH AS-2E | ~20 | (M4-98) | 10 | Water | DETAPMS | 80 | HCl |
| PVOH AS-2F | ~5 | (M4-98) | 10 | Water | DETAPMS | 20 | No |
| PVOH AS-2G | ~10 | (M4-98) | 10 | Water | DETAPMS | 50 | No |
| PVOH AS-2H | 1.3 | (M4-98) | 10 | Water | DETAPMS | 16 | No |
| PVOH AS-2I | 1.3 | (M4-98) | 10 | Water | DETAPMS | 32 | No |
| PVOH AS-3A | ~4 | (AQ4104) | 10 | 75 H₂O/ | DETAPMS | ~5 | No |
| | | | | 25 nPr | | | |
| PVOH AS-3B | ~4 | (AQ4104) | 10 | 75 H₂O/ | DETAPMS | ~10 | No |
| | | | | 25 nPr | | | |
| PVOH AS-3C | ~4 | (AQ4104) | 10 | 75 H₂O/ | APTES | | No |
| | | | | 25 nPr | | | |
| PVOH AS-3D | ~4 | (AQ4104) | 10 | 75 H₂O/ | APTES | | No |
| | | | | 25 nPr | | | |

Ketoester mol %: the percentage of the repeat units that have ketoester (KE) functionality. At a level of 10%, 1 in 10 of the PVOH units in the polymer will be KE functionalized.

Crosslinker mol %: the percentage of the KE functionality that is reacted with aminosilane. At a level of 50% this means that half of the KE groups should react with the crosslinker.

Z-200™ and OKS-3551™ (O3551) poly(vinyl alcohol) (PVA) functionalized with KE groups were obtained from Nippon Gohsei. All other polymer backbones were prepared by reacting diketene acetone adduct with MOWIOL 498™ (M4-98™, Kuraray) or EXCEVAL™ AQ-4104 (AQ-4104™, Kuraray) in DMSO solution. M4-98™ is a PVA with a viscosity of 4.0-5.0 MPas and a 98.0-98.8% degree of hydrolysis. AQ4104™ is a PVA with approximately 14% ethylene and a viscosity of 3.8-4.5 MPas and a 98.0-99.0% degree of hydrolysis. Sample AS 1G was manufactured as a control without KE functionalized PVA.

An estimate for the actual KE functionality grafted on is obtained using FT-IR. Values quoted for AQ4104™ are equivalent to a 100% vinyl alcohol material.

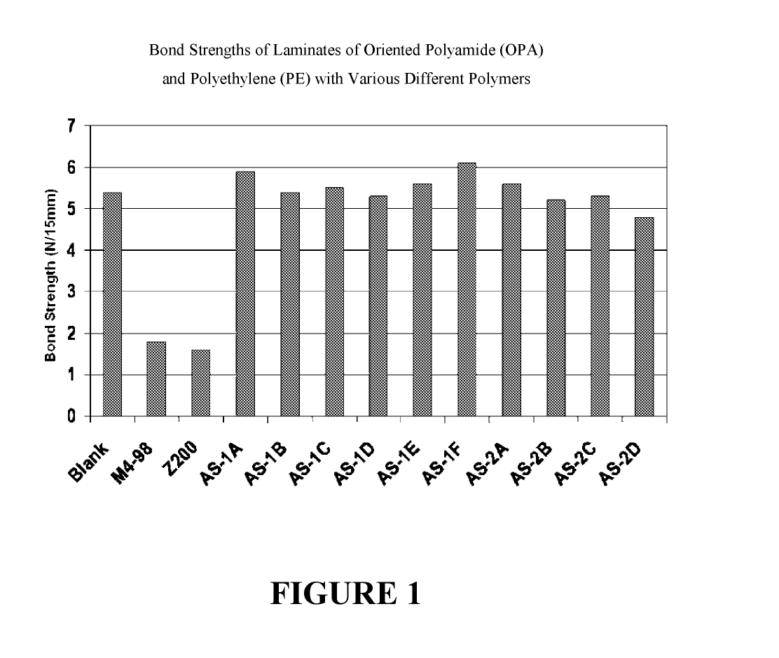

To evaluate the adhesive properties of the functionalized homo- and copolymers of vinyl alcohol, films of solutions of the same were cast on substrates representative of packaging materials and allowed to air dry. The packaging materials included oriented polyamide (OPA), and polyolefins such as polyethylene (PE) and polypropylene (PP) in an appropriate filmic format for use in packaging laminates. An adhesive typically used in the construction of such laminates was then applied to the top of the layer of the aminosilane modified polymer and a further layer of film placed on top, and air bubbles rubbed out from the laminate. After allowing the isocyanate adhesive to cure for a week, the resulting film was cut into strips for subsequent test. The adhesive potential of the barrier layer was then determined by looking at the bond strength between the two laminates using a conventional T-peel test. The test involved measuring the force in newtons (N) required to separate the polymer film from the substrate by pulling the two apart mechanically. The force required to break apart the laminates constructed with the functionalized polymers of the present invention was then compared with similar laminates made with unmodified and ketoester functionalized polymer backbone. The results obtained are summarised in FIG. 1.

As is evident from FIG. 1, it was observed that the addition of layers of the unmodified poly(vinyl alcohol) polymer backbone M4-98™ and ketoester modified poly(vinyl alcohol) polymer backbone Z-200™ undermined the bond strength of the adhesive. By contrast, the polymers modified with aminosilane retained a similar and in some cases greater degree of adhesion between the laminate layers.

A formulation was prepared in which unmodified polymer backbone was mixed with aminosilane (AS 1G) and the resulting adhesion of a laminate containing the polymer measured. There being no group for the amino group to attach itself to the backbone, the two exist as a mixture in solution and adhesion between the sheets in the resulting laminates was consequently very poor as expected. In this example the superior adhesion of the aminosilane functionalized homo- and copolymers of vinyl alcohol will allow them to be used in examples where otherwise it might not be possible to use a barrier layer.

In general, unmodified homo- and copolymer vinyl alcohol films are susceptible to attack from moisture or immersion in water. It was unexpectedly found that judicious levels of ketoester and aminosilane functionalization in polymer backbones could facilitate notable increases in the adhesion of laminates of orientated polypropylene (PP) and polyethylene (PE) film.

Several different aminosilanes were mixed with samples of a ketoester poly(vinyl alcohol) obtained from Nippon Gohsei (OKS 3551™) and films cast on glass slides which were cured or dried at 100° C. The fastness of the resulting coatings was tested by exposure to water solvent using ASTM test method number ASTM D 5402-06, Method A entitled “Standard Practice for Assessing the Solvent Resistance Of Organic Coatings Using Solvent Rubs” replacing methyl ethyl ketone with water. According to this test method, a cloth wetted with water was rubbed backwards and forwards along films of the polymers with an approximately constant amount of force of 1 to 2 Kg by means of a human hand. The number of rubs back and forth required for the films to fail was recorded. The results are summarised in the table below.

Relationship between aminosilane reacted with OKS-3551™ and resistance to water rubs:

TABLE 3

| Aminosilane | Number of Water Rubs |
|---|---|
| APTMS | 4 |
| APTES | 5 |
| ETAPMS | 4 |
| DETAPMS | >200 |

Unmodified poly(vinyl alcohol) starts to dissolve essentially immediately on contact with the damp cloth. By contrast, the APTMS, APTES and ETAPMS modified PVOHs were found to survive a little longer due to their more hydrophobic composition and enhanced adhesion. After several rubs under these severe conditions they however also started to peel as they had little or no crosslinking. The film of DETAPMS had crosslinked to significant or substantial degree upon curing and as a result it was able to withstand the duration of the test (200 rubs). Optionally, therefore the enhanced adhesion may also benefit from crosslinking with aminosilanes with multiple repeat ethyleneamine units to give it superior mechanical adhesion.

To evaluate the adhesive properties of the functionalized homo- and copolymers of vinyl alcohol in the ink or coating composition for use in rigid, flexible food and industrial packaging, films of solutions of the same were cast on substrates representative of packaging materials and allowed to air dry. The packaging materials included orientated polyamide (OPA), and polyolefins such as polyethylene (PE) and polypropylene (PP) in an appropriate filmic format for use in packaging laminates. The substrates tested in the above-mentioned process were freshly corona discharge treated 12 μm MELINEX S, 25 μm OPP (25MB400; ex. Exxon Mobil films) and a 25 μm OPA (nylon film), supplied by Sun Chemical (USA).

Then, the ink or coating compositions were applied with a No. 1 K-Bar, for example, as supplied by RK Print UK Ltd, delivering about 6 μm of wet film thickness onto the substrate. The coating was dried in a flow of warm air, e.g., laboratory prints dried with a hair dryer. The oxygen transmission rates of the coated substrate samples was evaluated using a Mocon Oxtran 2/21 gas permeability tester. The results are provided in more detail below.

The laminated packages were prepared by applying the ink or coating composition to the treated side of the plastic film, an adhesive was applied over the top of the dried coating and a further layer of film placed on top such a 30 μm gauge poly(ethylene) film. The air bubbles were rubbed out from the laminated package. The adhesive was supplied by Coim, NC250/CA350, and prepared according to the manufacturer's instructions and applied so as to achieve a final dry film weight of about 2.5 g. The laminates were then stored for about 10 to 14 days at 25° C. to ensure full cure of the isocyanate-based adhesive.

The resulting laminated package was cut into (15 mm wide) strips for testing. The bond strength between coated plastic film and the subsequently adhered film using a conventional T-peel test was assessed. The test involved measuring the force in newtons (N) required to separate the two polymer films by pulling the two apart mechanically. The force required to break apart the laminates constructed with the functionalized polymers of the present invention was then compared with similar laminates made with unmodified and ketoester functionalized polymer backbone.

As will be described in more detail herein, three examples of polymer formulations, Examples A, B and C, are provided below. Coating formulations 1a/b, 2a/b, 3a/b, 4a/b, 5a/b, 6a/b and 7a/b include at least one of Examples A, B or C. Oxygen transmission rates as well as bond strength were tested using two substrates, MELINEX S and 25MB400. Also provided are comparative examples 1a/b, 2a/b and 3a/b.

### Example A

### Preparation of Silane-Functional EVOH #1

8.0 g of REVBAR DK6 (>97.5% solids (w/w) keto-ester functional EVOH supplied by Revolymer) was dissolved in a mixture of 25 g of n-propanol and 67 g of deionized water, by heating to 60° C. After 60 minutes, all the polymer had dissolved and the solution was allowed to cool to 22° C. With stirring, 2.16 g of (3-aminopropyl)triethoxysilane was added and the mixture was stirred for 2 minutes. The mixture was then stored at 60° C. for 12 days to ensure that the reaction between the pendant ketone groups on the polymer and primary amine of the silane had reached completion.

### Example B

### Preparation of Silane-Functional EVOH #2

8.0 g of REVBAR DK8 (>97.5% solids w/w keto-ester functional EVOH supplied by Revolymer) was dissolved in a mixture of 25 g of n-propanol and 67 g of deionized water, by heating to 60° C. After 60 minutes, all the polymer had dissolved and the solution was allowed to cool to 22° C. With stirring, 2.88 g of (3-aminopropyl)triethoxysilane was added and the mixture was stirred for 2 minutes. The mixture was then stored at 60° C. for 12 days to ensure that the reaction between the pendant ketone groups on the polymer and primary amine of the silane had reached completion.

### Example C

### Preparation of Silane-Functional EVOH #3

8.0 g of REVBAR DK8, a keto-ester functional EVOH supplied by Revolymer, was dissolved in a mixture of 25 g of n-propanol and 67 g of deionized water, by heating to 60° C. After 60 minutes, all the polymer had dissolved and the solution was allowed to cool to 22° C. With stirring, 2.52 g of (3-aminopropyl)triethoxysilane was added and the mixture was stirred for 2 minutes. The mixture was then stored at 60° C. for 12 days to ensure that the reaction between the pendant ketone groups on the polymer and primary amine of the silane had reached completion.

### Example 1

### Preparation of a Gas Barrier Coating

5.6 grams of water was added to 27.6 g of Example A, and then 16.8 g of MICROLITE 963 (approx. 7.8% w/w solids aqueous dispersion of vermiculite supplied by W.R. Grace) was added thereto. The mixture was mixed using an ULTRA TURRAX T25 blender for 2 minutes. The coating was applied to a 12 micron gauge polyester film (MELINEX S), at 6 gsm (wet), and dried under a warm flow of air. The oxygen barrier of the coated film was measured to be 9.07 cm³/m²/day at 23° C. and 80% relative humidity (the oxygen barrier of the uncoated PET film was measured at 105.6 cm³/m²/day). The coating was then applied to PET and OPP films and laminated to a PE film according to the procedure outlined above. Table 1 provides the results of the bond strength testing for Examples 1-7. At 50% RH and 23° C., the OTR for the coated PET was less than 1.0 cm³/m²/day.

### Example 2

### Preparation of a Gas Barrier Coating

5.6 g of water was added to 22.8 g of Example A, and then 21.6 g of MICROLITE 963 was added thereto. The coating was prepared and tested in the same manner as Example 4. The oxygen barrier of the coated film was measured to be 7.60 cm³/m²/day at 23° C. and 80% relative humidity. At 50% RH and 23° C., the OTR for the coated PET was less than 1.0 cm³/m²/day.

### Example 3

### Preparation of a Gas Barrier Coating

A mixture of 3.0 g of ethanol/water and 4.2 g of deionized water was added to 23.6 g of Example B, and then 19.2 g of MICROLITE 963 was added thereto. The coating was prepared and tested in the same manner as Example 1. The oxygen barrier of the coated film was measured to be 6.63 cm³/m²/day at 23° C. and 80% relative humidity. At 50% RH and 23° C., the OTR for the coated PET was less than 1.0 cm³/m²/day.

### Example 4

### Preparation of a Gas Barrier Coating

A mixture of 3.0 g of ethanol/water and 4.2 g of deionized water was added to 26.8 g of Example C, and then 16.8 g of MICROLITE 963 was added thereto. The coating was prepared and tested in the same manner as Example 1. The oxygen barrier of the coated film was measured to be 12.85 cm³/m²/day at 23° C. and 80% relative humidity. At 50% RH and 23° C., the OTR for the coated PET was less than 1.0 cm³/m²/day.

### Example 5

### Preparation of a Gas Barrier Coating

A mixture of 3.0 g of ethanol/water and 3.1 g of deionized water was added to 24.7 g of Example 3 was, and then 19.2 g of MICROLITE 963 was added thereto. The coating was prepared and tested in the same manner as Example 1. The oxygen barrier of the coated film was measured to be 7.90 cm³/m²/day at 23° C. and 80% relative humidity. At 50% RH and 23° C., the OTR for the coated PET was less than 1.0 cm³/m²/day.

### Example 6

### Preparation of a Gas Barrier Coating

A mixture of 3.0 g of ethanol/water and 3.0 g of deionized water was added to 22.7 g of Example C, and then 21.6 g of MICROLITE 963 was added thereto. The coating was prepared and tested in the same manner as Example 1. The oxygen barrier of the coated film was measured to be 6.41 cm³/m²/day at 23° C. and 80% relative humidity. The oxygen barrier of this coated film was also measured at 23° C. and 50% and 75% relative humidity, and found to provide a barrier of 0.34 and 4.43 respectively.

### Example 7

### Preparation of Gas Barrier Coating with Lower Aspect Ratio Clay

30.2 g of a 3.9% (w/w) dispersion of a bentonite clay dispersion (SUNBAR (SX012) O₂ BARRIER 1.1 PART B; ex. Sun Chemical) was added to 19.8 g of Example B. The coating was prepared and tested in the same manner as Example 1. The oxygen barrier of the coated film was measured to be 72.31 cm³/m²/day at 23° C. and 80% relative humidity. At 50% RH and 23° C., the OTR was less than 1 cc/m2/day.

The oxygen barrier of this coated film was measured at 50% relative humidity, and found to provide a barrier of 0.95 cm³/m²/day.

### Comparative Example 1

### Gas Barrier Coating w/o Silane and w/o Keto-Ester

8.0 g of EXCEVAL AQ4104, a PVOH supplied by Kuraray, was dissolved in a mixture of 25 g of n-propanol and 67 g of deionized water, and heated to 85° C. After 60 minutes, the polymer dissolved and the solution was allowed to cool to 22° C. A mixture of 3.0 g of ethanol and 3.0 g of deionised water was added to 26.3 g of this solution, and then 17.9 g of MICROLITE 963 was added thereto. The coating was prepared and tested in the same manner as Example 1. The oxygen barrier of the coated film was measured to be 3.63 cm³/m²/day at 23° C. and 80% relative humidity.

### Comparative Example 2

### Gas Barrier Coating without Silane and Keto-Ester and Containing a Lower Aspect Ratio Clay

8.0 g of EXCEVAL AQ4104, a PVOH supplied by Kuraray, was dissolved in a mixture of 25 g of n-propanol and 67 g of deionized water, and heated to 85° C. After 60 minutes, the polymer had dissolved and the solution was allowed to cool to 22° C. 29.0 g of a 3.9% (w/w) dispersion of a bentonite clay dispersion (SUNBAR (SX012) O₂ BARRIER 1.1 PART B; ex. Sun Chemical was added to 21.0 g of this solution. The coating was prepared and tested in the same manner as Example 1. The oxygen barrier of the coated film was measured to be 46.06 cm³/m²/day at 23° C. and 80% relative humidity.

### Comparative Example 3

### Gas Barrier Coating w/o Silane

8.0 g of REVBAR DK6, a keto-ester functional EVOH supplied by Revolymer, was dissolved in a mixture of 25 g of n-propanol and 67 g of deionized water, and heated to 60° C. After 60 minutes, all the polymer had dissolved and the solution was allowed to cool to 22° C. A mixture of 3.0 g ethanol and 4.0 g of deionised water was added to 19.5 g of this solution, and then 13.3 g of MICROLITE 963 was added thereto. The coating was prepared and tested in the same manner as Example 1. The oxygen barrier of the coated film was measured to be 36.04 cm³/m²/day at 23° C. and 80% relative humidity.

TABLE 4

| | | Bond | Bond | Bond |
|---|---|---|---|---|
| | | Strength | Strength | Strength |
| | | (22° C., | (38° C., | (2 hr. water |
| | | 45% RH) | 85-90% RH) | immersion) |
| Example | Substrate | (N/15 mm) | (N/15 mm) | (N/15 mm) |
| 1a | MELINEX S | 3.2 | 0.6 | 0.2¹ |
| 1b | 25MB400 | 3.3 | 0.8 | 1.4 |
| 2a | MELINEX S | 3.3 | 0.4 | 0.3¹ |
| 2b | 25MB400 | 3.6 | 0.7 | 1.1 |
| 3a | MELINEX S | 3.1 | 2.2 | 0.4¹ |
| 3b | 25MB400 | 3.5 | 3.5 | 1.6 |
| 4a | MELINEX S | 3.1 | 2.9 | 0.6¹ |
| 4b | 25MB400 | 3.3 | 3.6 | 2.1 |
| 5a | MELINEX S | 3.2 | 2.0 | — |
| 5b | 25MB400 | 3.1 | 3.2 | — |
| 6a | MELINEX S | 3.0 | 2.8 | 0.3¹ |
| 6b | 25MB400 | 3.6 | 3.6 | 1.8 |
| 7a | MELINEX S | 3.0 | 2.6 | 0.6¹ |
| 7b | 25MB400 | 3.6 | 2.4 | 0.6¹ |
| CE 1a | MELINEX S | 0.3 | <0.1 | <0.1² |
| CE 1b | 25MB400 | 0.2 | <0.1 | <0.1² |
| CE 2a | MELINEX S | 2.4 | 0.3 | <0.1² |
| CE 2b | 25MB400 | 0.3 | <0.1 | <0.1² |
| CE 3a | MELINEX S | 0.2 | <0.1 | <0.1 |
| CE 3b | 25MB400 | 0.2 | <0.1 | <0.1 |

¹When these laminates were allowed to dry for 6 hours at 22° C. and 45% RH, the bond strengths recovered totally to that measured previously at 22° C. and 45% RH.
²After being immersed in water, these laminates started to show signs of catastrophic failure, with the PE film becoming separated from either the PET or OPP coated films.

The main contribution to the immersion bond strength performance is the starting concentration of ketoester, if the majority of this is subsequently reacted with aminosilane. The inventors prefer that the concentration of keto-ester is greater than 4.0 mol % but less than 10 mol %. We have achieved the best balance of oxygen barrier performance and bond strength performance with a sample of EXCEVAL AQ4104 modified with between 5 and 7 mol % of keto-ester and subsequently largely substituted with amino silane. If the keto-ester functional PVOHs are not modified with aminosilane then the subsequent bond strength, particularly at high humidity and after water immersion are poor (<0.5N/15 mm). Equally, any significant levels of unreacted aminosilane cause flocculation of the vermiculite dispersion (ionic destabilization). This can be shown by adding small amounts of the aminosilane (APTEOS) to the vermiculite dispersion.

Examples 1a/b and 2a/b included the polymer REVBAR DK6. These examples exhibited good oxygen barrier performance, at low humidity, e.g., 22° C. and 45% RH stored for 2 days, and high humidity, e.g., 28° C. and 85-90% RH stored for 1 day. Both examples exhibited good bond strength at lower humidity while marginal bond strength at higher humidity. Namely, 1a/b and 2a/b exhibited bond strengths of 3.2 N/15 mm, 3.3 N/15 mm, 3.3 N/15 mm and 3.6 N/15 mm, respectively. The bond strength at high humidity for Examples 1a/b and 2a/b were 0.6 N/15 mm, 0.8 N/15 mm, 0.4 N/15 mm and 0.7 N/15 mm. Good bond strength also was exhibited for Examples 1b and 2b upon immersion of the Melinix S substrate in water for two hours followed by a 6-hour recovery.

Examples 3a/b & 5a/b included the polymer REVBAR DK8. These examples exhibited good oxygen barrier performance at low and high humidity. These examples exhibited good bond strength performance was exhibited after water immersion as illustrated in Table 4.

Examples 4a/b included the polymer REVBAR DK8 with a reduced amount of clay in relation to Examples 3a/b and 5a/b, and exhibited good oxygen barrier performance at low and high relative humidity. However, the instant results were not as favorable as those for examples 3a/b and 5a/b. As shown in Table 4, good bond strength performance was exhibited at low and high humidity. Good bond strength performance also was exhibited after water immersion for example 4b utilizing the MELINEX S substrate.

Examples 6a/b included polymer REVBAR DK8 with an increased amount of clay in relation to Examples 3a/b, 4a/b and 5a/b. Examples 6a/b exhibited good oxygen barrier performance at low and high humidity. As shown in Table 4, good bond strength performance was exhibited at low and high humidity. In addition, good bond strength performance was exhibited after water immersion for example 4b utilizing the MELINEX S substrate.

Examples 7a/b included a coating including DK8 and a lower aspect ratio clay. The coatings exhibited good oxygen barrier performance at low humidity, however, oxygen barrier performance high relative humidity was not as favorable as Examples 1a/b-6a/b. Examples 7a/b exhibited good bond strength at low and high humidity as well as good bond strength upon water immersion.

Comparative Examples 1a/b included an oxygen barrier coating without silane and keto-ester. Examples 1a/b exhibited good oxygen barrier performance at low and high relative humidity. However, Comparative Examples 1a/b exhibited poor bond strength at low and high humidity and also when immersed in water as shown in Table 4.

Comparative Examples 2a/b included an oxygen barrier coating without silane and keto-ester and containing lower aspect ratio clay. Comparative Examples 2a/b exhibited poor oxygen barrier performance at high humidity. Comparative Example 2b did however exhibit good bond strength at low humidity. To the contrary, Comparative Example 2a exhibited poor bond strength at low humidity as shown in Table 4. Both examples exhibited poor bond strength at high humidity and water immersion characteristics.

Comparative Examples 3a/b included an oxygen barrier coating without silane. Comparative Examples 3a/b exhibited poor oxygen barrier performance at high relative humidity. Comparative Examples 3a/b exhibited poor bond strength at high and low humidity as well as poor water immersion characteristics as shown in Table 4.

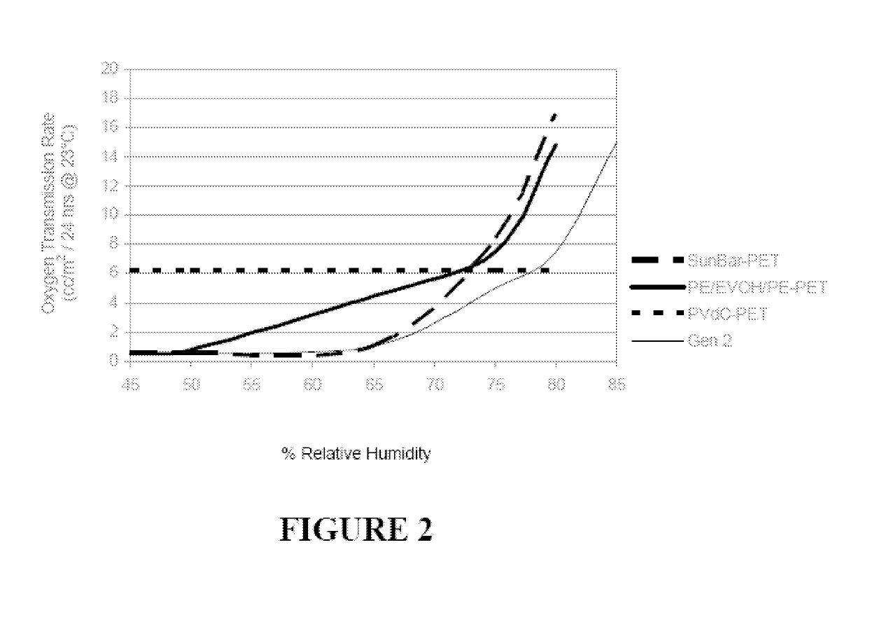

As shown in FIG. 2, various the relative humidity of various polymers are examined upon storage for 24 hours at 23° C. Gen 2 is the polymer according to the present invention. As illustrated, Gen 2 has the lowest OTR among the four tested samples at any given relative humidity between about 65 and 78%. At a relative humidity less than about 65%, Applicants' SUNBAR-PET has a comparable OTR. Example 6 is an example of Gen 2. Gen 2 is depicted as a thin solid line in FIG. 2. SUNBAR-PET is a 12 micron PET film coated with a 6 micron wet film of SUNBAR (SX011-SX012) O₂ barrier coating prepared according to the manufacturer's instructions. SUNBAR-PET is depicted as a thick dashed line in FIG. 2. PE/EVOH/PE-PET is an adhesively-formed laminate of a 12 micron PET film laminated to a 3-ply co-extruded film of PE, EVOH and PE where the EVOH layer thickness is of the order 3-5 microns and the total thickness of the triple ply film is of the order of 50-60 microns. PE/EVOH/PE-PET is depicted as a thick solid line in FIG. 2. Lastly, PVdC-PET is a 12 micron PET film having an approximately 3 micron thick coating of PVdC. PVdC-PET is depicted as a think dashed line in FIG. 2.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

What is claimed is:

1. A functionalized homopolymer or copolymer of vinyl alcohol of formula (I):
P—(R)ₙ (I)
where:
P represents a straight or branched chain polymer backbone that is a homopolymer of vinyl alcohol or a copolymer of vinyl alcohol and at least one other monomer, the homopolymer or copolymer comprising one or more reactive coupling group;
R represents an aminosilane-containing and/or an aminosilanol-containing side chain attached to the polymer backbone via the one or more reactive coupling group; and
n represents the number of side chains, which are present in an amount from about 1 to about 25 mol % of the polymer backbone;
provided that when P represents a homopolymer of vinyl alcohol, then R is not a side chain derived from 3-aminopropyltriethoxysilane.

2. The polymer according to claim 1, wherein P represents poly(vinyl alcohol).

3. The polymer according to claim 1, wherein P represents a copolymer of vinyl alcohol and an olefin.

4. The polymer according to claim 3, wherein the olefin is present in an amount from about 1 to about 50 mol % of the copolymer backbone.

5. The polymer according to claim 1, wherein P represents a copolymer of vinyl alcohol and an alkene-containing monomer.

6. The polymer according to claim 5, wherein the alkene-containing monomer is selected from the group consisting of acrylic acid, acrylonitrile, and acrylamide.

7. The polymer according to claim 5, wherein the alkene-containing monomer is selected from the group consisting of methacrylic acid, methyl methacrylate, 2-hydroxyethyl acrylate, hydroxyl methacrylate, ethyl methacrylate, and n-butyl methacrylate.

8. The polymer according to claim 1, wherein P represents a copolymer of vinyl alcohol and acetoacetoxyethyl methacrylate.

9. The polymer according to claim 1, wherein the reactive coupling group comprises a ketone-containing or ketoester-containing functional group.

10. The polymer according to claim 9, wherein the reactive coupling group comprises a ketoester-containing functional group derived from an acetoacetylation agent.

11. The polymer according to claim 10, wherein the acetoacetylation agent is diketene, diketene acetone adduct, or an alkyl acetoacetate.

12. The polymer according to claim 10, wherein the ketoester-containing functional group comprises the moiety —O(CO)CH—C(CH₃)═O.

13. The polymer according to claim 9, wherein the ketone-containing or ketoester-containing functional group is present in an amount from about 1 to about 50 mol % of the polymer backbone.

14. The polymer according to claim 1, wherein the side chain R is derived from a compound of general formula (IIA): 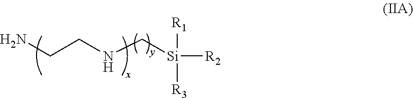
where:
R₁, R₂ and R₃ independently represent H, C₁₋₉ alkyl, aryl, C₁₋₉ alkoxy or aryloxy, provided that at least one of R₁, R₂ or R₃ represents a C₁₋₉ alkoxy or aryloxy group;
x is in a range from 0 to 9; and
y is in a range from 1 to 9.

15. The polymer according to claim 14, wherein x is 0, 1, or 2 and y is 3.

16. The polymer according to claim 14, wherein at least two of R₁, R₂, and R₃ are independently selected from the group consisting of methoxy, ethoxy, propoxy, and butoxy.

17. The polymer according to claim 14, wherein the side chain R is derived from one or more of the following compounds: aminoethyl triethoxy silane, 2-aminoethyl trimethoxy silane, 2-aminoethyl triethoxy silane, 2-aminoethyl tripropoxy silane, 2-aminoethyl tributoxy silane, 1-aminoethyl trimethoxy silane, 1-aminoethyl triethoxy silane, 3-aminopropyl trimethoxy silane, 3-aminopropyl triethoxy silane, 3-aminopropyl tripropoxy silane, 3-aminopropyl tributoxy silane, 3-aminopropyl methyl dimethoxysilane, 3-aminopropyl ethyl dimethoxysilane, 3-aminopropyl-3-aminopropyldiethylethoxysilane ethyl diethoxysilane, 3-aminopropyl methyl dipropoxysilane, 3-aminopropyl ethyl dipropoxysilane, 3-aminopropyl propyl dipropoxysilane, 3-aminopropyl dimethyl methoxysilane, 3-aminopropyl dimethyl ethoxysilane, 3-aminopropyl diethyl ethoxysilane, 3-aminopropyl dimethyl propoxysilane, 3-aminopropyl diethyl propoxysilane, 3-aminopropyl dipropyl propoxysilane, 2-aminopropyl trimethoxy silane, 2-aminopropyl triethoxy silane, 2-aminopropyl tripropoxy silane, 2-aminopropyl tributoxy silane, 1-aminopropyl trimethoxy silane, 1-aminopropyl triethoxy silane, 1-aminopropyl tripropoxy silane, 1-aminopropyl tributoxy silane, N-aminomethyl aminomethyl trimethoxy silane, N-aminomethyl aminomethyl tripropoxy silane, N-aminomethyl-2-aminoethyl trimethoxy silane, N-aminomethyl-2-aminoethyl triethoxy silane, N-aminomethyl-2-aminoethyl tripropoxy silane, N-aminomethyl-3-aminopropyl trimethoxy silane, N-aminomethyl-3-aminopropyl triethoxy silane, N-aminomethyl-3-aminopropyl tripropoxy silane, N-aminomethyl-2-aminopropyl trimethoxy silane, N-aminomethyl-2-aminopropyl triethoxy silane, N-aminomethyl-2-aminopropyl tripropoxy silane, N-aminopropyl trimethoxy silane, N-aminopropyl triethoxy silane, N-(2-aminoethyl)-2-aminoethyl trimethoxy silane, N-(2-aminoethyl)-2-aminoethyl triethoxy silane, N-(2-aminoethyl)-2-aminoethyl tripropoxy silane, N-(2-aminoethyl)-aminoethyl trimethoxy silane, N-(2-aminoethyl)-1-aminoethyl triethoxy silane, N-(2-aminoethyl)-1-aminoethyl tripropoxy silane, N-(2-aminoethyl)-3-aminopropyl triethoxy silane, N-(2-aminoethyl)-3-aminopropyl tripropoxy silane, N-(3-aminopropyl)-2-aminoethyl trimethoxy silane, N-(3-aminopropyl)-2-aminoethyl triethoxy silane, N-(3-aminopropyl)-2-aminoethyl tripropoxy silane, N-methyl-3-aminopropyl trimethoxy silane, 3-aminopropyl methyl dimethoxy silane, 3-aminopropyl methyl diethoxy silane, N-(2-aminoethyl)-3-aminopropyl methyl dimethoxy silane, 3-diethylene 3-diethylene triamine propyl triethoxy silane, 3-[2-(2-aminoethyl aminoethyl amino)propyl]trimethoxysilane, 3-[2-(2-aminoethyl aminoethyl amino) propyl]triethoxysilane, 3-[2-(2-aminoethyl aminoethyl amino) propyl]tripropoxysilane, and trimethoxy silyl propyl diethylene triamine.

18. The polymer according to claim 17, wherein the side chain R is derived from one or more of the following compounds: 3-aminopropyl trimethoxysilane, 3-aminopropyl triethoxysilane, N-(2-Aminoethyl)-3-aminopropyl trimethoxysilane, N-(2-Aminoethyl)-3-aminopropyl triethoxysilane, 3-[2-(2-aminoethylamino)ethylamino]propyl trimethoxysilane, 3-[2-(2-aminoethylamino)ethylamino]propyl triethoxysilane, and 3-aminopropyl methyldimethoxysilane.

19. The polymer according to claim 1, wherein the side chains R are present in an amount from about 5 to about 200 mol % relative to the amount of reactive coupling groups present on the polymer backbone.

20. The polymer according to claim 1, wherein the side chains R are present in an amount from about 2 to about 15 mol % of the polymer backbone.

21. A process for preparing a functionalized vinyl alcohol homopolymer or copolymer according to claim 1, comprising the steps of:
a. preparing a straight or branched chain homopolymer of vinyl acetate or a copolymer of vinyl acetate with at least one other monomer;
b. hydrolysing the homopolymer or copolymer of vinyl acetate of step (a) to obtain a homopolymer or copolymer of vinyl alcohol;
c. reacting the homopolymer or copolymer of vinyl alcohol of step (b) with a suitable reactive coupling agent to obtain a homopolymer or copolymer of vinyl alcohol comprising one or more reactive coupling groups;
d. reacting the resulting homopolymer or copolymer of vinyl alcohol comprising one or more reactive coupling groups of step (c) with a suitable aminosilane and/or an aminosilanol; and
e. optionally isolating the copolymer so formed.

22. The process according to claim 21, wherein step (b) comprises partial hydrolysis of the vinyl acetate copolymer.

23. The process according to claim 21, wherein the reaction mixture obtained following step (d) is heated to a temperature in a range from about 0 to about 100° C.

24. The process according to claim 21, wherein step (d) is performed by adding the homopolymer or copolymer of vinyl alcohol comprising one or more reactive coupling groups to a solution of a suitable aminosilane and/or an aminosilanol.

25. The process according to claim 21, wherein the reaction mixture obtained following step (d) is treated with an acid.

26. The process according to claim 21, wherein the reaction mixture obtained following step (d) is treated with carbon dioxide.

27. The process according to claim 21, wherein the copolymer is isolated by evaporation.

28. A functionalized homopolymer or copolymer of vinyl alcohol obtainable by or obtained by the process of claim 21.

29. A process for preparing a cross-linked polymer coating, comprising:
heating a polymer containing more than one aminosilane and/or aminosilanol side-chains derived from a compound of formula (III), wherein the process is carried out in the absence of an acid catalyst, 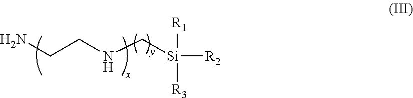
where:
R₁, R₂, and R₃ independently represent H, C₁₋₉ alkyl, aryl, C₁₋₉ alkoxy or aryloxy, provided that at least one of R₁, R₂, or R₃ represents a C₁₋₉ alkoxy or aryloxy group;
x is in a range from 2 to 9; and
y is in a range from 3 to 9.

30. The process according to claim 29, wherein the polymer is heated to a temperature of from about 80 to about 120° C.

31. A composition comprising:
the polymer according to claim 1; and
water or a mixture of water and a C₁₋₄ alcohol.

32. The polymer according to claim 3, wherein the olefin is ethylene or propylene.

33. A sealant or adhesive comprising the functionalized homopolymer or copolymer of vinyl alcohol according to claim 1.

34. The adhesive or sealant according to claim 33, wherein the functionalized homopolymer or copolymer of vinyl alcohol is used a binder.

36. A cross-linked polymer coating obtainable by or obtained by the process according to claim 29.

38. An ink or coating composition comprising a functionalized homopolymer or copolymer of vinyl alcohol according to the formula:
P—(R)ₙ
where:
P comprises a straight or branched chain polymer backbone comprising a homopolymer or copolymer of vinyl alcohol, a monomer, and a reactive coupling group comprising a ketone-containing or ketoester-containing functional group;
R comprises an aminosilane-containing and/or aminosilanol-containing side chain attached to the polymer backbone via the reactive coupling group; and
n is the number of side chains ranging from about 1 to about 25 mol % of the polymer backbone.

39. The ink or coating composition according to claim 38, wherein the ketoester-containing functional group is derived from an acetoacetylation agent selected from a diketene, diketene acetone adduct, methyl acetoacetate, ethyl acetoacetate, tert-butyl acetoacetate, tert-pentyl acetoacetate, and combinations thereof.

40. The ink or coating composition according to claim 38, wherein the ketone-containing or ketoester-containing functional group is present in an amount from about 1 to 50 mol % of the polymer backbone.

41. The ink or coating composition according claim 38, wherein the copolymer side chain R is derived from a compound according to the formula: 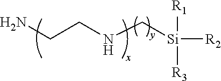
where:
R₁, R₂, and R₃ is selected from H, C₁₋₉ alkyl, aryl, and C₁₋₉ alkoxy or aryloxy, wherein at least one of R₁, R₂ or R₃ is C₁₋₉ alkoxy or aryloxy group;
x is 0 to 9; and
y is 1 to 9.

42. The ink or coating composition according claim 38, wherein the side chain R is about 2 to 15 mol % of the polymer backbone.

43. The ink or coating composition according to claim 41, wherein the side chain R is derived from a compound selected from 3-aminopropyl trimethoxysilane, 3-aminopropyl triethoxysilane, N-(2-Aminoethyl)-3-aminopropyl trimethoxysilane, N-(2-Aminoethyl)-3-aminopropyl triethoxysilane, 3-[2-(2-aminoethylamino)ethylamino]propyl trimethoxysilane, 3-[2-(2-aminoethylamino)ethylamino]propyl triethoxysilane 3-aminopropyl methyldimethoxysilane, and combinations thereof.

44. The ink or coating composition according to claim 38, wherein the side chain R is about 50 to 150 mol % relative to an amount of the reactive coupling.

45. The ink or coating composition according to claim 38, wherein a weight % ratio of the aminosilane to the keto-ester reactive coupled vinyl copolymer or homopolymer ranges from about 1:2 to 1:100.

46. The ink or coating composition according to claim 38, wherein the monomer is selected from olefins, vinylic monomers, acetoacetoxyethyl methacrylates, diacetone acrylamides, and combinations thereof.

47. The ink or coating composition according to claim 46, wherein the olefin is about 1 to about 50 mol % of the polymer backbone.

48. The ink or coating composition according to claim 47, wherein the olefin is less than about 20 mol % of the polymer backbone.

49. The ink or coating composition according to claim 38, further comprising a clay.

50. The ink or coating composition according to claim 49, wherein the clay is a vermiculite.

51. The ink or coating composition according to claim 49, wherein a total solids content of the composition ranges from about 0.5 to 15% w/w.

52. The ink or coating composition according to claim 51, wherein the clay ranges from about 30 to 55% w/w of the total solids content.

53. The ink or coating composition according to claim 51, wherein the polymer backbone is about 30 to 95 wt % of the total solids content of the composition.

54. The ink or coating composition according to claim 49, exhibiting an oxygen transmission rate less than about 13 cm³/m²/day at 23° C. and 80% relative humidity.

55. The ink or coating composition according to claim 49, exhibiting an oxygen transmission rate less than about 1 cm³/m²/day at 23° C. and 50% relative humidity.

56. A package comprising:
at least one substrate; and
the coating composition according to claim 38.

57. The package according to claim 56 being a cured laminate package.

58. The cured laminate package according to claim 57, further comprising an adhesive.

59. The package according to claim 56, wherein the substrate is flexible.

60. The package according to claim 56, wherein the substrate is a plastic polymeric film.

61. The package according to claim 56, wherein the substrate is a paper substrate.

62. The package according to claim 56, wherein the substrate is a paperboard.

63. The package of claim 62, wherein the paperboard is coated with polyester or polyolefin.

64. The cured laminate package according to claim 57, exhibiting a laminate bond strength greater than about 3.0 N/15 mm after being stored for about 48 hours at 38° C. and 85-90% relative humidity.

65. The cured laminate package according to claim 57, exhibiting a laminate bond strength greater than about 0.5 N/15 mm after being stored for about 24 hours at 38° C. and 85-90% relative humidity.

66. The cured laminate according to claim 57, exhibiting a laminate bond strength greater than about 0.6 N/15 mm after immersion in water for 2 hours at 22° C.

67. A process for making the package of claim 56, comprising coating the substrate with the coating composition of claim 38.

68. The process of claim 67, wherein the coating composition acts as a barrier in food and industrial applications.

69. The process of claim 67, wherein the coating composition acts as a gas barrier in food and industrial applications.

70. The process of claim 67, wherein the coating composition acts as a barrier in modified atmosphere packaging for food and industrial applications.
